(19) United States
(12) Patent Application Publication
(10) Pub. No.: US 2016/0379144 A1
(43) Pub. Date: Dec. 29, 2016

(54) INFORMATION PROCESSING SYSTEM AND FAILURE PREDICTION MODEL ADOPTION DETERMINING METHOD

(71) Applicants: Satoshi MIZUNO, Tokyo (JP); Takenori OKU, Tokyo (JP); Hiroshi NISHIDA, Kanagawa (JP); Shunsuke HAYASHI, Kanagawa (JP); Kentaro SEO, Tokyo (JP); Yusuke SHIBATA, Tokyo (JP); Yuuta SANO, Tokyo (JP); Takeyoshi SEKINE, Tokyo (JP); Fumihiro NAGANO, Kanagawa (JP); Satoshi HATANAKA, Kanagawa (JP); Kenji UEDA, Kanagawa (JP)

(72) Inventors: Satoshi MIZUNO, Tokyo (JP); Takenori OKU, Tokyo (JP); Hiroshi NISHIDA, Kanagawa (JP); Shunsuke HAYASHI, Kanagawa (JP); Kentaro SEO, Tokyo (JP); Yusuke SHIBATA, Tokyo (JP); Yuuta SANO, Tokyo (JP); Takeyoshi SEKINE, Tokyo (JP); Fumihiro NAGANO, Kanagawa (JP); Satoshi HATANAKA, Kanagawa (JP); Kenji UEDA, Kanagawa (JP)

(73) Assignee: Ricoh Company, Ltd., Tokyo (JP)

(21) Appl. No.: 15/191,731

(22) Filed: Jun. 24, 2016

(30) Foreign Application Priority Data
Jun. 29, 2015 (JP) 2015-129736
Jul. 1, 2015 (JP) 2015-132335

(51) Int. Cl. G06Q 10/06; G06Q 40/00

(52) U.S. Cl. CPC G06Q 10/0635; G06Q 10/067; G06Q 40/00

(57) ABSTRACT

An information processing system includes at least one information processing apparatus. The information processing system includes a provisional cost calculator configured to apply failure history information to a failure prediction model to provisionally calculate a cost of the failure prediction model, the failure history information expressing failure history of at least one electronic device in which a failure has occurred, the failure prediction model including a symptom detection method for detecting a symptom of a failure to occur in the electronic device in association with a preventive action for preventing the failure to occur in the electronic device; and an adoption determiner configured to determine to adopt the failure prediction model by which a profit can be obtained, based on a result of the provisional calculation.

### CROSS-REFERENCE TO RELATED APPLICATION

The present application claims priority under 35 U.S.C. §119 to Japanese Patent Application No. 2015-129736, filed on Jun. 29, 2015, and Japanese Patent Application No. 2015-132335, filed on Jul. 1, 2015. The contents of which are incorporated herein by reference in their entirety.

### BACKGROUND OF THE INVENTION

1. Field of the Invention

The present disclosure relates to information processing systems and failure prediction model adoption determining methods.

2. Description of the Related Art

In recent years, for electronic devices such as copiers and printers, a failure prediction model is used to detect symptoms of failures and to take actions required for preventing failures. A failure prediction model sets a method of detecting an electronic device in which a failure is likely to occur (failure prediction logic), and a method of taking an optimum action for preventing failures with respect to an electronic device for which a symptom of a failure has been detected by the failure prediction logic (preventive action).

For example, there is known a typical image forming apparatus management system having the following configuration. Specifically, each of the image forming apparatuses sends state information expressing the state of the own apparatus to a management device. The management device receives the state information and then analyzes the contents of the state information. Then, the management device selectively sends information relevant to maintenance or repair of the image forming apparatus, to the respective terminal devices (see, for example, patent document 1).

For example, failure prediction models corresponding to various phenomena are being developed on a daily basis. The developed failure prediction models are adopted, for example, for detecting a symptom of a failure based on information collected from an electronic device, and reporting a method of taking the optimum action for preventing failures to a customer engineer (CE).

For image forming apparatuses such as copiers, etc., the timing of performing maintenance work, such as inspecting the image forming apparatus and replacing components, is determined based on a result of estimating the deterioration degree of components and the timing of failures, etc.

Furthermore, there is known a technology of creating a maintenance plan for an image forming apparatus based on the relationship between the frequency of operations of the image forming apparatus and the life of consumables, etc. (see, for example, patent document 2).

Here, for example, when a failure of a high degree of severity is predicted to occur in a few days in an image forming apparatus that is a maintenance target, a workman (service technician, etc.) needs to be quickly dispatched to the image forming apparatus to prevent the occurrence of a failure. On the other hand, for example, when a failure of a low degree of severity is predicted to occur after a certain period of days in the image forming apparatus, the workman is to perform maintenance according to a maintenance plan.

Patent Document 1: Japanese Unexamined Patent Application Publication No. 2004-37941

Patent Document 2: Japanese Unexamined Patent Application Publication No. 2011-181073

### SUMMARY OF THE INVENTION

The present disclosure provides an information processing system and a failure prediction model adoption determining method, in which one or more of the above-described disadvantages are eliminated.

According to one aspect of the present disclosure, there is provided an information processing system including at least one information processing apparatus, the information processing system including a provisional cost calculator configured to apply failure history information to a failure prediction model to provisionally calculate a cost of the failure prediction model, the failure history information expressing failure history of at least one electronic device in which a failure has occurred, the failure prediction model including a symptom detection method for detecting a symptom of a failure to occur in the electronic device in association with a preventive action for preventing the failure to occur in the electronic device; and an adoption determiner configured to determine to adopt the failure prediction model by which a profit can be obtained, based on a result of the provisional calculation.

### BRIEF DESCRIPTION OF THE DRAWINGS

Other objects, features and advantages of the present disclosure will become more apparent from the following detailed description when read in conjunction with the accompanying drawings, in which:

FIG. 1 is a schematic block diagram illustrating an example of a device management system according to embodiments of the present disclosure;

FIG. 2 is a block diagram of an example of a hardware configuration of a computer according to the embodiments of the present disclosure;

FIG. 3 is a block diagram of an example of a hardware configuration of a device according to the embodiments of the present disclosure;

FIG. 4 is a process block diagram of an example of a management device according to a first embodiment of the present disclosure;

FIG. 5 is a process block diagram of an example of a failure prediction model developing unit according to the first embodiment of the present disclosure;

FIG. 6 is a diagram illustrating an example of a process of searching for a data pattern of state information that commonly occurs before a failure occurs, according to the first embodiment of the present disclosure;

FIGS. 7A and 7B are diagrams illustrating examples of the precision of failure prediction logic according to the first embodiment of the present disclosure;

FIG. 8 is a diagram illustrating examples of indexes expressing the precision of failure prediction logic according to the first embodiment of the present disclosure;

FIG. 9 is a diagram illustrating an example of a preventive action determined when the precision of the failure prediction logic is high, according to the first embodiment of the present disclosure;

FIG. 10 is a diagram illustrating an example of a preventive action determined when the precision of the failure prediction logic is not high, according to the first embodiment of the present disclosure;

FIG. 11 is a diagram illustrating an example of a failure prediction model according to the first embodiment of the present disclosure;

FIG. 12 is a diagram illustrating a formula for calculating the total service cost with respect to a failure according to the first embodiment of the present disclosure;

FIG. 13 is a diagram illustrating four patterns according to the result of detecting a symptom of a failure by the failure prediction logic (prediction hit/missed) and whether a plus-one action is possible/not possible, according to the first embodiment of the present disclosure;

FIGS. 14A and 14B are diagrams illustrating examples of provisionally calculating the service cost effectiveness in the case of selecting a preventive action according to plus-one, according to the first embodiment of the present disclosure;

FIG. 15 is a diagram illustrating an example of a result of provisionally calculating the service cost effectiveness when a preventive action according to plus-one is selected, according to the first embodiment of the present disclosure;

FIG. 16 is a graph illustrating an example of variations of the current output value of the sensor A, according to the first embodiment of the present disclosure;

FIG. 17 is a diagram illustrating an example of a result of provisionally calculating the service cost effectiveness in the case of an emergency visit, according to the first embodiment of the present disclosure;

FIG. 18 is a graph illustrating an example of variations of the current output value of the sensor B and the developing Y toner density, according to the first embodiment of the present disclosure;

FIG. 19 is a flowchart illustrating an example of an action flow by the CE in the case of an emergency visit, according to the first embodiment of the present disclosure;

FIG. 20 is a diagram illustrating an example of the cause of a failure (error B), according to the first embodiment of the present disclosure;

FIG. 21 is a diagram illustrating an example of classification of the failure (error B), according to the first embodiment of the present disclosure;

FIG. 22 is a graph illustrating an example of variations in the sensor light amount, according to the first embodiment of the present disclosure;

FIG. 23 is a process block diagram illustrating a functional configuration of an example of the management device according to a second embodiment of the present disclosure;

FIG. 24 is a perspective view of an example of an action determination model according to the second embodiment of the present disclosure;

FIGS. 25A through 25E are a cross-sectional views of examples of the action determination model according to the second embodiment of the present disclosure;

FIG. 26 is a flowchart of an example of a process of determining the action content according to the second embodiment of the present disclosure;

FIG. 27 is a diagram illustrating an example of device state information according to the second embodiment of the present disclosure;

FIG. 28 is a diagram illustrating an example of failure prediction information according to the second embodiment of the present disclosure;

FIG. 29 is a diagram illustrating an example of device management information according to the second embodiment of the present disclosure;

FIG. 30 is a diagram illustrating an example of an emergency arrangement screen according to the second embodiment of the present disclosure;

FIG. 31 is a diagram illustrating an example of a maintenance plan screen according to the second embodiment of the present disclosure;

FIG. 32 is a process block diagram illustrating a functional configuration of an example of the management device 10 according to a third embodiment of the present disclosure;

FIG. 33 is a diagram illustrating an example of customer attribute information according to the third embodiment of the present disclosure; and

FIG. 34 is a flowchart of an example of a process of determining the action content according to the third embodiment of the present disclosure.

### DETAILED DESCRIPTION OF THE PREFERRED EMBODIMENTS

A problem to be solved by an embodiment of the present disclosure is to provide an information processing system that is capable of provisionally calculating a cost when a failure prediction model is implemented and adopting a failure prediction model that is profitable.

A problem to be solved by an embodiment of the present disclosure is to support the process of determining action content according to a predicted failure.

Embodiments of the present disclosure will be described with reference to the accompanying drawings.

### <System Configuration>

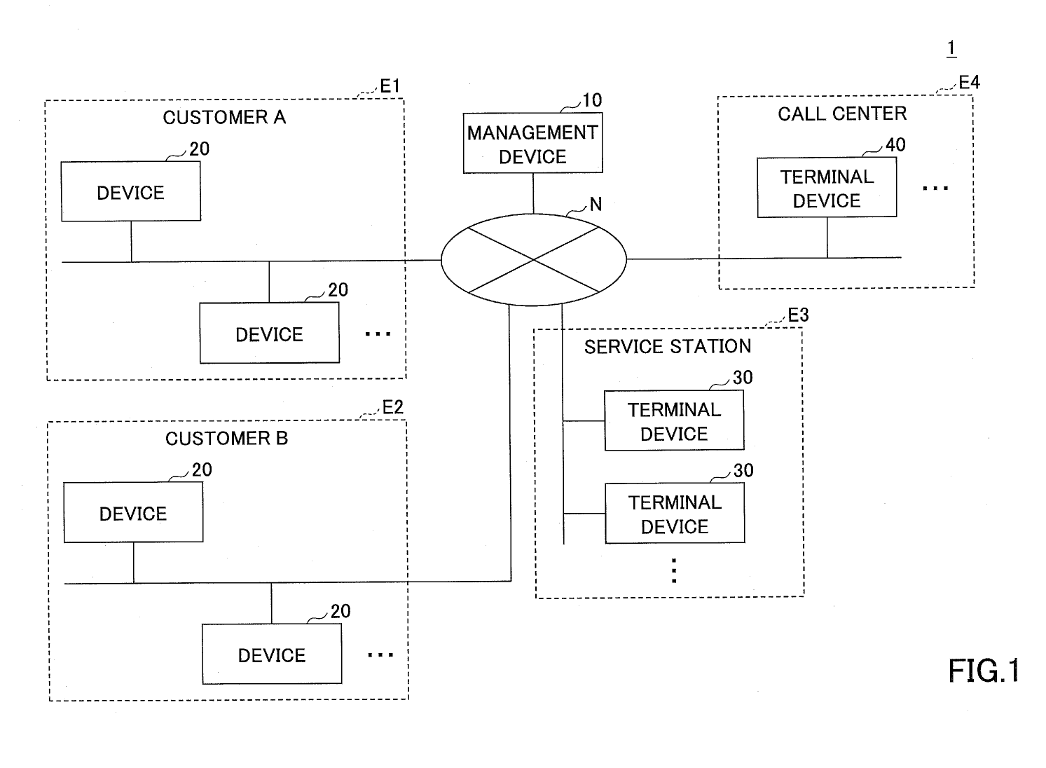

First, a description is given of a device management system 1 according to embodiments of the present disclosure, referring to FIG. 1. FIG. 1 is a schematic block diagram illustrating an example of the device management system 1 according to the embodiments of the present disclosure.

The device management system 1 according to the present embodiment includes a management device 10, a plurality of devices 20, a terminal device 30, and a terminal device 40, which are communicatively connected to each other via a network N such as the Internet and a telephone line network, etc.

The management device 10 predicts that a failure will occur in the device 20 based on information (device state information) collected from the device 20, and determines the action content expressing how to handle the predicted failure according to the prediction result. Then, the management device 10 reports the action content to the terminal device 30 deployed in a service station environment E3 or the terminal device 40 deployed in a call center environment E4.

Note that the management device 10 illustrated in FIG. 1 includes a single information processing apparatus (computer); however, the management device 10 is not so limited, and the management device 10 may include a plurality of information processing apparatuses.

The device 20 may be an image forming apparatus such as a copier and a printer, etc., deployed in a customer environment E1 indicating a business place of a customer A who is a user, etc., and a customer environment E2 indicating a business place of a customer B who is a user, etc. The device 20 sends device state information to the management device 10. The device state information includes, for example, measurement values, etc., of the current, the voltage, and the temperature, etc., of various components, etc., included in the device 20 as measured by various sensors at predetermined time intervals.

Note that the device 20 according to the present embodiment is described as being an image forming apparatus such as a copier, etc.; however, the device 20 is not limited to an image forming apparatus. For example, the device 20 may be various kinds of devices such as a projector, an electronic blackboard, a TV conference terminal, and a digital signage device, etc.

The terminal device 30 is deployed, for example, in the service station environment E3 indicating a business place of a business operator that has sold or leased the device 20. The terminal device 30 is a personal computer (PC), etc., used by a workman (service technician, etc.) such as a customer engineer (CE) who is to perform maintenance or repair on the device 20. Note that the terminal device 30 may be various kinds of information processing apparatuses such as a tablet terminal and a smartphone, etc.

The worker who is a customer engineer (hereinafter referred to as “CE, etc.”) is able to perform maintenance on the device 20 based on the action content reported to the terminal device 30 from the management device 10.

The terminal device 40 is deployed, for example, in a call center environment E4 indicating a call center of a business operator that has sold or leased the device 20. The terminal device 40 is a PC, etc., that is used by an operator or a dispatcher who dispatches the CE, etc., to the customer. Note that the terminal device 40 may be various kinds of information processing apparatuses such as a tablet terminal and a smartphone, etc.

The operator or the dispatcher (hereinafter referred to as “operator, etc.”) requests a CE, etc., to perform maintenance on the device 20 deployed in the customer environment E1 or the customer environment E2 based on the action content reported to the terminal device 40 from the management device 10, and dispatches the CE, etc., to the customer.

By the device management system 1 illustrated in FIG. 1, the CE, etc., is able to appropriately perform maintenance on the device 20 according to a failure predicted by the management device 10.

That is, in the present embodiment, for example, when a failure having a high degree of severity is detected, etc., the operator, etc., quickly dispatches a CE, etc., to the device 20 in which the failure is predicted, and requests the CE, etc., to perform an appropriate maintenance work such as replacing components, etc. On the other hand, when a failure that does not have a high degree of severity is detected, etc., the CE, etc., performs the maintenance work on the device 20 in which the failure is detected, within a maintenance plan. As described above, the device management system 1 according to the preset embodiment provides support such that the CE, etc., is able to perform appropriate maintenance according to the degree of severity of the failure that is predicted to occur in the device 20.

### <Hardware Configuration>

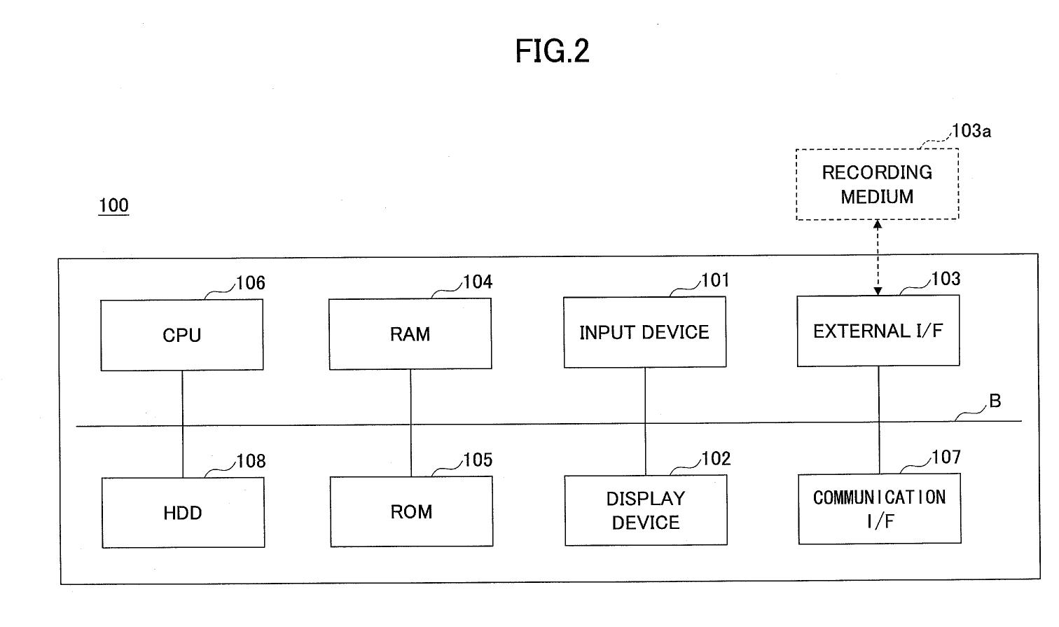

Next, a hardware configuration of the management device 10, the terminal device 30, and the terminal device 40 according to the embodiments is described referring to FIG. 2. FIG. 2 is a block diagram of an example of a hardware configuration of a computer according to the embodiments of the present disclosure.

A computer 100 illustrated in FIG. 2 includes an input device 101, a display device 102, an external interface (I/F) 103, and a Random Access Memory (RAM) 104. Furthermore, the computer 100 includes a Read-Only Memory (ROM) 105, a Central Processing Unit (CPU) 106, a communication I/F 107, and a Hard Disk Drive (HDD) 108. These hardware elements are connected to each other by a bus B.

The input device 101 includes a keyboard, a mouse, and a touch panel, etc., and is used for inputting various signals in the computer 100. The display device 102 includes a display, etc., and displays various processing results. Note that the management device 10 may have a mode in which the input device 101 and/or the display device 102 are connected to the bus B and used according to need.

The external I/F 103 is an interface between the computer 100 and an external device. An example of an external device is a recording medium such as a Compact Disk (CD), a Digital Versatile Disk (DVD), a Secure Digital (SD) memory card, and a Universal Serial Bus (USB) memory, etc. The computer 100 is able to read and/or write information in the recording medium via the external I/F 103.

The RAM 104 is a volatile semiconductor memory (storage device) for temporarily storing programs and data. The ROM 105 is a non-volatile semiconductor memory (storage device) that can store data even after the power is turned off. The CPU 106 is an arithmetic device that loads, for example, the programs and data of the HDD 108 and the ROM 105, etc., into the RAM 104, and executes various processes.

The communication I/F 107 is an interface for connecting the computer 100 to the network N. The HDD 108 is a non-volatile memory (storage device) storing programs and data. The programs and data stored in the HDD 108 include programs for realizing the present embodiment, the Operating System (OS) that is the basic software for controlling the entire computer 100, and various application programs operating on the OS, etc. Note that the computer 100 may include a non-volatile memory (storage device) such as Solid State Drive (SSD), etc., instead of the HDD 108 or together with the HDD 108.

The management device 10, the terminal device 30, and the terminal device 40 according to the present embodiment can implement various processes described below, by the computer 100 illustrated in FIG. 2.

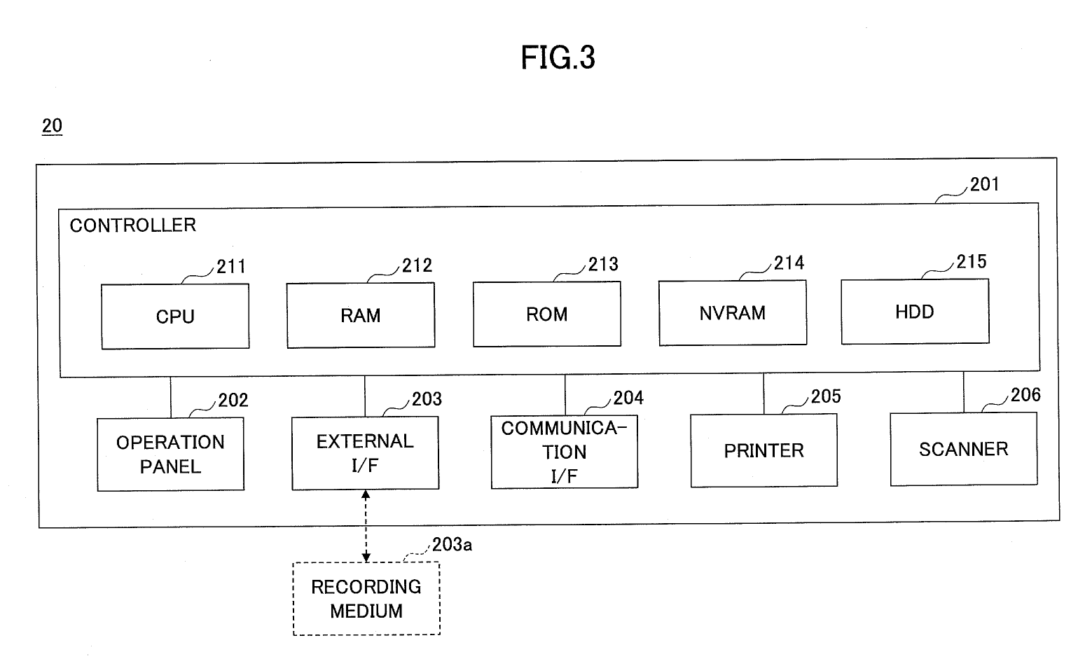

Next, a description is given of a hardware configuration of the device 20 according to the embodiments. FIG. 3 is a block diagram of an example of a hardware configuration of the device 20 according to the embodiments of the present disclosure.

The device 20 illustrated in FIG. 3 includes a controller 201, an operation panel 202, an external I/F 203, a communication I/F 204, a printer 205, and a scanner 206.

Furthermore, the controller 201 includes a CPU 211, a RAM 212, a ROM 213, a Non-Volatile Random Access Memory (NVRAM) 214, and a HDD 215.

The ROM 213 stores various programs and data. The RAM 212 temporarily stores programs and data. The NVRAM 214 stores, for example, setting information, etc. Furthermore, the HDD 215 stores various programs and data.

The CPU 211 controls the entire device 20 and realizes functions of the device 20, by loading the programs, data, and setting information, etc., from the ROM 213, the NVRAM 214, and the HDD 215, into the RAM 212, and executing processes.

The operation panel 202 includes an input device for accepting input from a user, and a display device for displaying information. The external I/F 203 is an interface between the device 20 and an external device. An example of the external device is a recording medium 203a. Accordingly, the device 20 is able to read and/or write information in the recording medium 203a via the external I/F 203. Examples of the recording medium 203a are an integrated circuit (IC) card, a flexible disk, a CD, a DVD, an SD memory card, and a USB memory, etc.

The communication I/F 204 is an interface that connects the device 20 to the network N. Accordingly, the device 20 is able to perform data communication via the communication I/F 204. The printer 205 is a printing device for printing print data onto a sheet. The scanner 206 is a reading device for reading an original document and generating image data (electronic data).

The device 20 according to the present embodiment can implement various processes described below, by the above hardware configuration.

### First Embodiment

### <Software Configuration>

<<Management Device>>

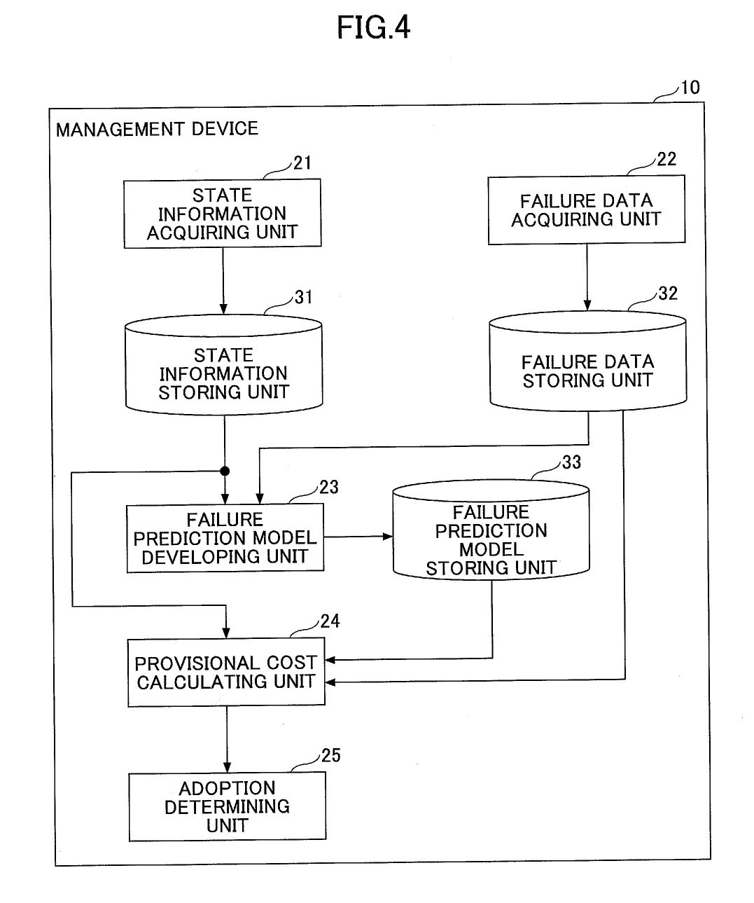

The management device 10 according to a first embodiment is realized by, for example, the process blocks illustrated in FIG. 4. FIG. 4 is a process block diagram of an example of the management device 10 according to the first embodiment of the present disclosure.

The management device 10 executes programs to realize a state information acquiring unit 21, a failure data acquiring unit 22, a failure prediction model developing unit 23, a provisional cost calculating unit 24, an adoption determining unit 25, a state information storing unit 31, a failure data storing unit 32, and a failure prediction model storing unit 33.

The state information acquiring unit 21 acquires state information including a plurality of variables relevant to the device 20, and stores the state information in the state information storing unit 31. The state information is a current output value of a sensor disposed in the device 20, and information relevant to the degree of consumption of a consumable component (for example, a counter value and a usage frequency), etc.

The failure data acquiring unit 22 acquires the failure data of the device 20, and stores the failure data in the failure data storing unit 32. The failure data is information relevant to the state information (a current output value of a sensor and a degree of consumption of a consumable component) when a failure occurs.

The failure prediction model developing unit 23 uses the state information in the state information storing unit 31 and the failure data in the failure data storing unit 32, to perform statistical analysis to develop failure prediction logic and to determine a preventive action, and develop a failure prediction model. The failure prediction model developing unit 23 may automatically develop a failure prediction model, or may support the development of a failure prediction model by a data analyzer. The failure prediction model developing unit 23 stores the developed failure prediction model in the failure prediction model storing unit 33.

The provisional cost calculating unit 24 uses the state information in the state information storing unit 31 and the failure data in the failure data storing unit 32 to provisionally calculate the service cost effectiveness in a case where the developed failure prediction model is implemented.

For example, the provisional cost calculating unit 24 provisionally calculates the increase in the service cost when the developed failure prediction model is implemented and the decrease in the service cost when the developed failure prediction model is implemented.

The adoption determining unit 25 adopts a failure prediction model by which profits can be obtained, based on the result of provisionally calculating the service cost effectiveness in a case where the developed failure prediction model is implemented. For example, when the decrease in the service cost when a developed failure prediction model is implemented is higher than the increase in the service cost when the developed failure prediction model is implemented, the adoption determining unit 25 adopts the failure prediction model as a model with which profits can be obtained. Note that the determination of adopting a failure prediction model by the adoption determining unit 25 may be performed at each location where a CE is based.

Note that there may be various standards of determining whether the failure prediction model is profitable. For example, a failure prediction model by which the service cost can be decreased and a failure prediction model by which the service cost can be decreased by a predetermined ratio are conceivable.

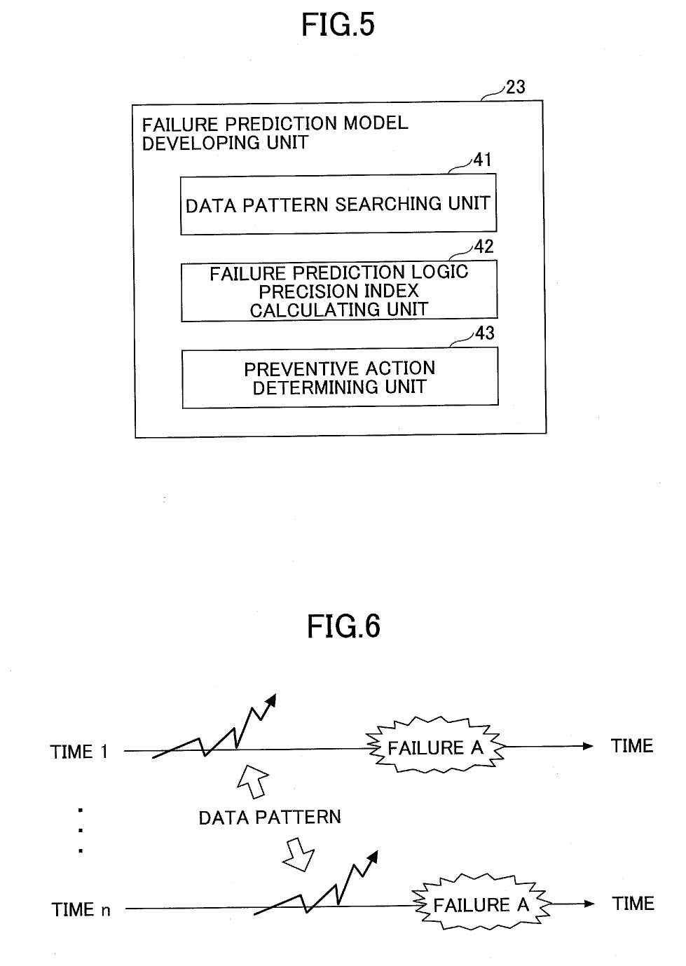

The failure prediction model developing unit 23 in FIG. 4 is realized by, for example, process blocks illustrated in FIG. 5. FIG. 5 is a process block diagram of an example of the failure prediction model developing unit 23 according to the first embodiment of the present disclosure. The failure prediction model developing unit 23 includes a data pattern searching unit 41, a failure prediction logic precision index calculating unit 42, and a preventive action determining unit 43.

The data pattern searching unit 41 uses the state information in the state information storing unit 31 and the failure data in the failure data storing unit 32 to search for a data pattern of state information that commonly occurs before a failure occurs.

The failure prediction logic precision index calculating unit 42 calculates the precision of the failure prediction logic (the probability that a failure occurs after the data pattern occurs). For example, the failure prediction logic precision index calculating unit 42 according to the present embodiment calculates two indexes of a hit ratio and a cover ratio described below, as indexes expressing the precision of the failure prediction logic. The preventive action determining unit 43 determines the preventive action according to the precision of the failure prediction logic.

### <Details of Process>

In the following, a description is given of details of processes performed by the device management system 1 according to the present embodiment.

<<Searching for Data Pattern>>

The data pattern searching unit 41 uses the state information in the state information storing unit 31 and the failure data in the failure data storing unit 32 to search for a data pattern of state information that commonly occurs before a failure occurs, as illustrated in FIG. 6.

FIG. 6 is a diagram illustrating an example of a process of searching for a data pattern of state information that commonly occurs before a failure occurs, according to the first embodiment of the present disclosure. The data pattern searching unit 41 searches for a data pattern that commonly occurs before a failure A occurs, based on failure history of the device 20. The failure history is expressed by the state information in the state information storing unit 31 and the failure data in the failure data storing unit 32. Note that the relationship between the failure A and the data pattern that commonly occurs before the failure A, is the failure prediction logic. The management device 10 is able to detect a symptom of the failure A by detecting the occurrence of the data pattern that has been found as a result of the search.

<<Calculation of Precision of Failure Prediction Logic>>

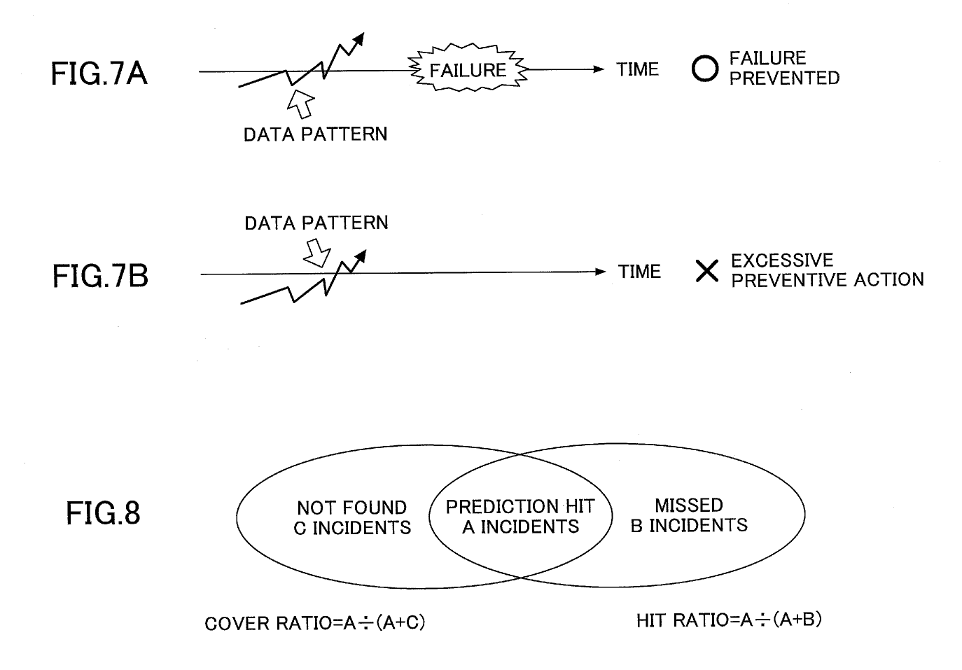

FIGS. 7A and 7B are diagrams illustrating examples of the precision of the failure prediction logic according to the first embodiment of the present disclosure. Here, it is assumed that the management device 10 has detected a symptom of a failure according to the occurrence of the data pattern that has been found by the data pattern searching unit 41, and that the management device 10 has taken a preventive action.

FIG. 7A illustrates that a failure has actually occurred after the data pattern has occurred. When a failure actually occurs after the data pattern has occurred as in this case, the preventive action realizes prevention of a failure.

FIG. 7B illustrates that a failure has not actually occurred after the data pattern has occurred. When a failure does not actually occur after the data pattern has occurred as in this case, the implemented preventive action becomes an excessive action.

Therefore, the data pattern searching unit 41 searches for a data pattern by which the case of FIG. 7A occurs frequently and the case of FIG. 7B does not occur frequently, from among the data patterns that commonly occur before a failure occurs.

FIG. 8 is a diagram illustrating examples of indexes expressing the precision of failure prediction logic according to the first embodiment of the present disclosure. FIG. 8 illustrates a hit ratio and a cover ratio as indexes expressing the precision of failure prediction logic. The failure prediction logic is a formula for detecting a data pattern that commonly occurs before a failure occurs.

The results of detecting a symptom of a failure by the failure prediction logic includes, for example, the three cases of prediction hit, missed, and not found. Prediction hit is a case where a symptom of a failure is detected by the failure prediction logic and the failure has actually occurred. Missed is a case where a symptom of a failure is detected by the failure prediction logic but the failure has not actually occurred. Not found is a case where a symptom of a failure cannot be detected by the failure prediction logic but the failure has actually occurred.

The precision of the failure prediction logic is expressed by the two indexes of cover ratio and hit ratio indicated in FIG. 8. The cover ratio indicates the ratio of the number of incidents of prediction hit to the number of incidents of (prediction hit+not found). That is, the cover ratio is an index that expresses the ratio of failures that can be detected by the data pattern. Furthermore, the hit ratio indicates the ratio of the number of incidents of prediction hit to the number of incidents of (prediction hit+missed). That is, the hit ratio is an index that indicates the ratio of symptoms of a failure that has actually occurred, and the hit ratio indicates the probability of a failure occurring after the data pattern occurs.

<<Determination of Preventive Action>>

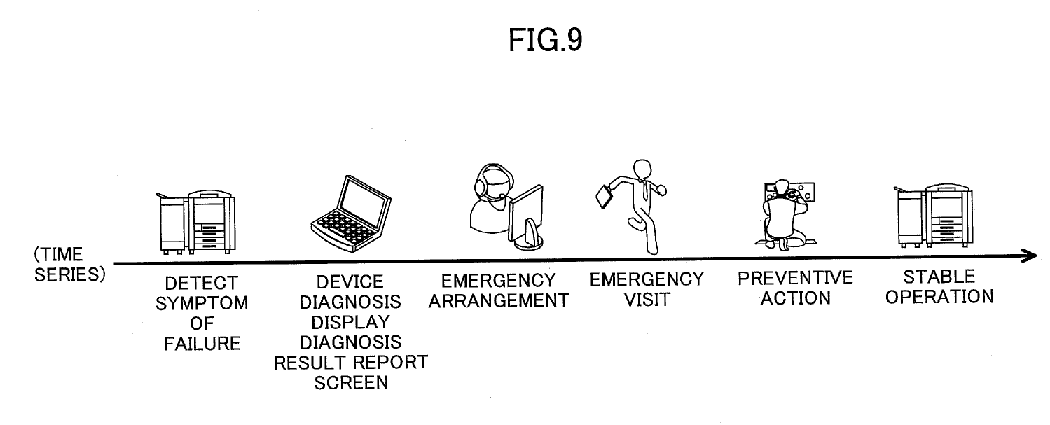

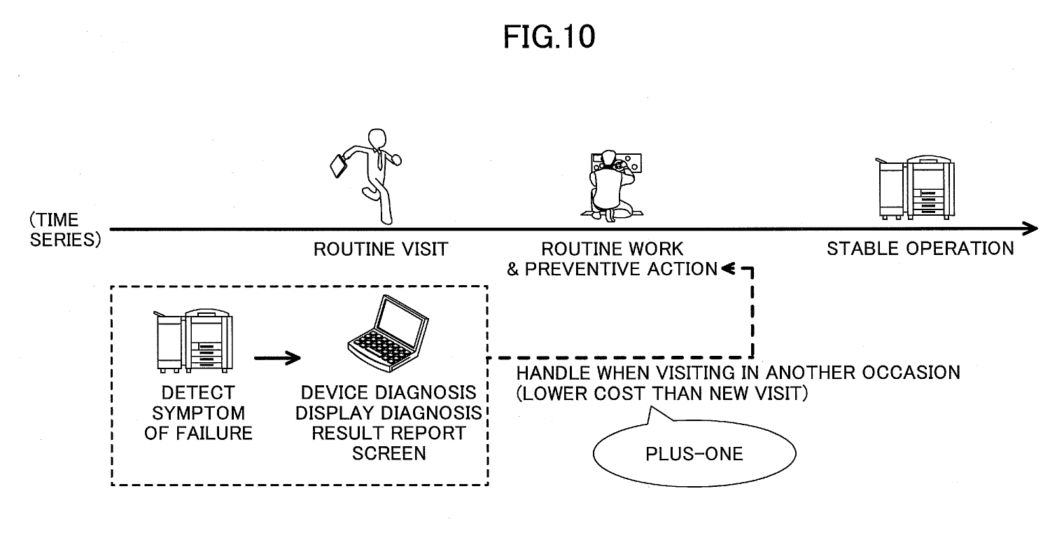

The preventive action determining unit 43 determines the preventive action according to the precision of the failure prediction logic indicated by a hit ratio, as illustrated in FIG. 9 or FIG. 10. FIG. 9 is a diagram illustrating an example of a preventive action determined when the precision of the failure prediction logic is high, according to the first embodiment of the present disclosure. FIG. 10 is a diagram illustrating an example of a preventive action determined when the precision of the failure prediction logic is not high, according to the first embodiment of the present disclosure.

As illustrated in FIG. 9, when the precision of the failure prediction logic is high, the preventive action determining unit 43 selects an emergency visit as a preventive action. In this case, a failure is almost certain to occur after a test pattern occurs, and therefore the preventive action determining unit 43 selects a preventive action to be implemented before a failure occurs by an emergency arrangement.

Furthermore, as illustrated in FIG. 10, when the precision of the failure prediction is not high, the preventive action determining unit 43 selects incidental work (plus-one) as a preventive action. When the management device 10 predicts an increase of cases where the preventive action results in a missed state, the preventive action determining unit 43 causes a workman to implement a preventive action as plus-one, which is incidental work performed in the course of routine work, to implement a preventive action for a failure while avoiding a cost increase due to missed predictions.

<<Failure Prediction Model>>

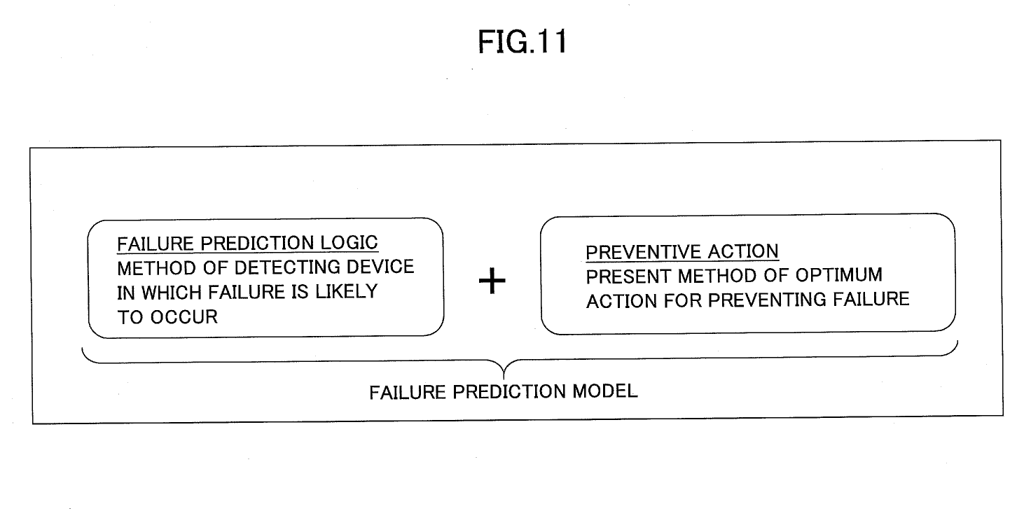

FIG. 11 is a diagram illustrating an example of a failure prediction model according to the first embodiment of the present disclosure. In the failure prediction model in FIG. 11, failure prediction logic and a preventive action are associated with each other. The failure prediction logic indicates a method of detecting a device in which a failure is likely to occur. Furthermore, the preventive action presents a method of an optimum action for preventing a failure, with respect to an electronic device in which a symptom of a failure is detected according to the failure prediction logic.

The failure prediction model developing unit 23 calculates the precision of the failure prediction logic, selects a preventive action according to the precision of the failure prediction logic as illustrated in FIG. 9 or FIG. 10, and develops a failure prediction model in which the selected preventive action and the failure prediction logic are associated with each other.

<<Provisional Calculation of Cost>>

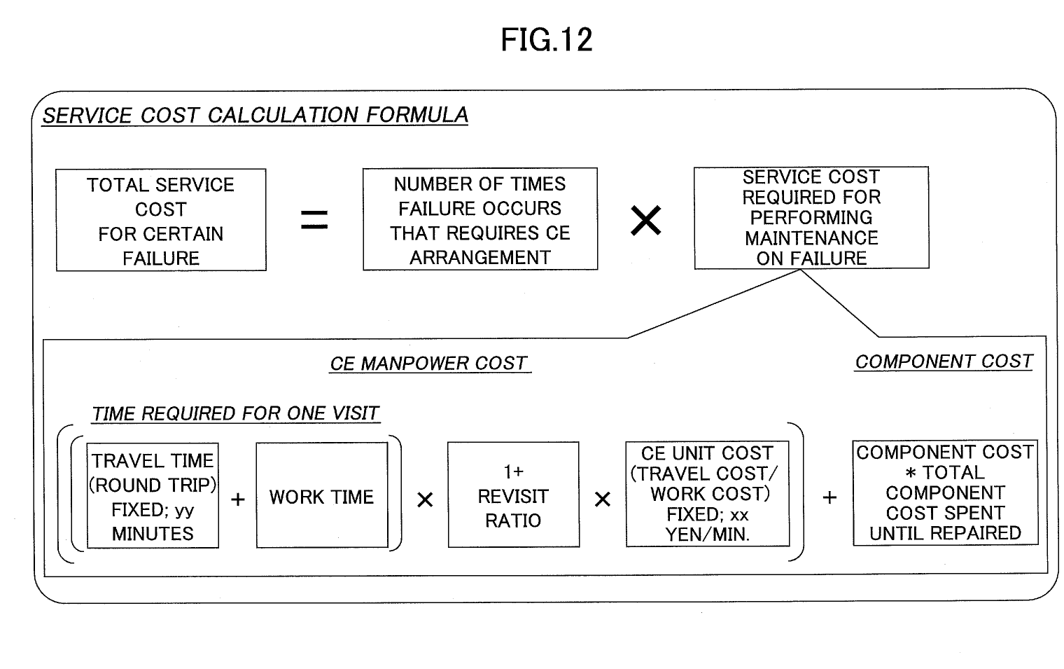

The provisional cost calculating unit 24 calculates a service cost, for example, as illustrated in FIG. 12. FIG. 12 illustrates an example of a service cost calculation formula. FIG. 12 is a diagram illustrating a formula for calculating the total service cost with respect to a failure according to the first embodiment of the present disclosure.

As illustrated in FIG. 12, the formula for calculating the total service cost with respect to a failure includes multiplying the number of times a failure that requires CE arrangement occurs, by the service cost involved for performing maintenance on the failure.

Furthermore, the service cost required for performing maintenance on the failure includes the manpower cost of the CE and the component cost. The manpower cost of the CE is calculated by multiplying the time required for one visit, the 1+revisit ratio, and the CE unit price, as indicated in FIG. 12. Furthermore, the component cost is the total component cost required for performing maintenance on the failure. The time required for one visit is expressed by the travel time and the work time. Furthermore, the travel time varies according to the distance from the location where the CE is based to the location where the device 20 is deployed.

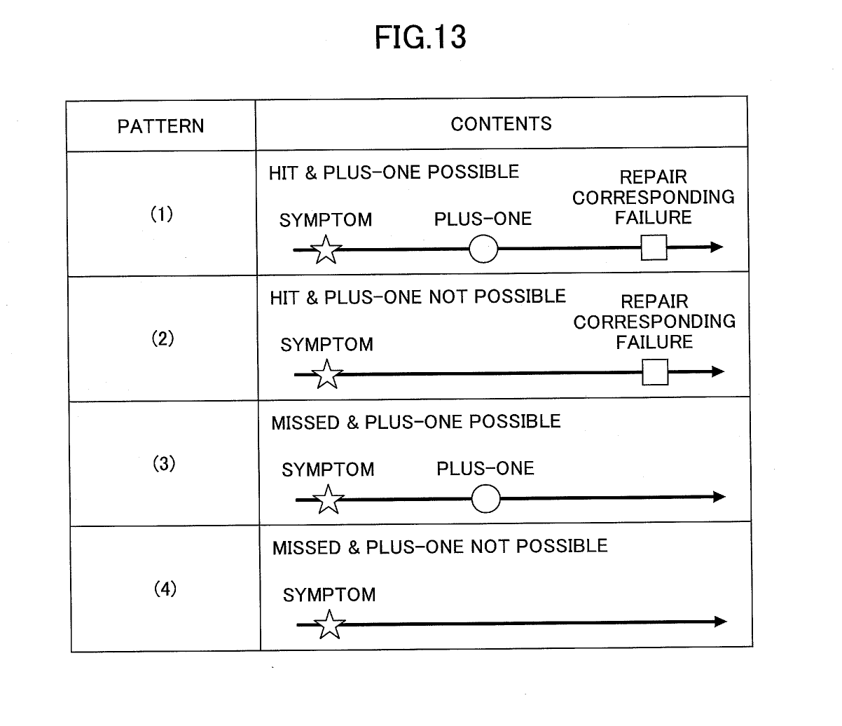

For example, the provisional cost calculating unit 24 provisionally calculates the service cost effectiveness in a case where a preventive action according to plus-one is selected, as follows. FIG. 13 is a diagram illustrating four patterns according to the result of detecting a symptom of a failure by the failure prediction logic (prediction hit/missed) and whether a plus-one action is possible/not possible, according to the first embodiment of the present disclosure.

In FIG. 13, pattern (1) is a case where the result of detecting a symptom of a failure by failure prediction logic is prediction hit, and a plus-one action is possible. Furthermore, in FIG. 13, pattern (2) is a case where the result of detecting a symptom of a failure by failure prediction logic is prediction hit, and a plus-one action is not possible.

In FIG. 13, pattern (3) is a case where the result of detecting a symptom of a failure by failure prediction logic is missed, and a plus-one action is possible. Furthermore, in FIG. 13, pattern (4) is a case where the result of detecting a symptom of a failure by failure prediction logic is missed, and a plus-one action is not possible.

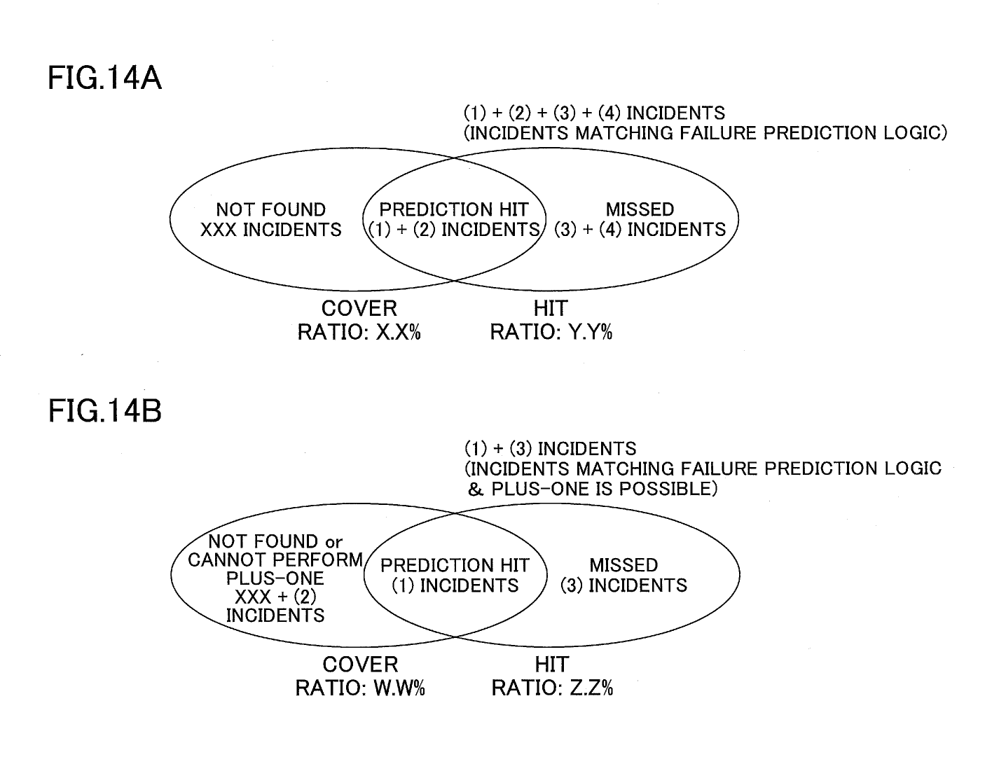

FIGS. 14A and 14B are diagrams illustrating examples of provisionally calculating the service cost effectiveness in the case of selecting a preventive action according to plus-one, according to the first embodiment of the present disclosure. In FIG. 14A, the patterns (1) through (4) of FIG. 13 are classified into cases of prediction hit, missed, and not found indicated in FIG. 8. In FIG. 14A, the numbers of incidents of pattern (1) and pattern (2) are classified in prediction hit, and the numbers of incidents of pattern (3) and pattern (4) are classified in missed.

Here, in order to describe the provisional calculation of the service cost effectiveness in a case of selecting a preventive action according to plus-one, the numbers of incidents are narrowed down to the numbers of incidents of pattern (1) and pattern (3) in which a plus-one action is possible, as illustrated in FIG. 14B. In FIG. 14B, the number of incidents of pattern (1) is classified in prediction hit, and the number of incidents of pattern (3) is classified in missed.

In the case of FIG. 14B, the provisional cost calculating unit 24 calculates the service cost that arises by the plus-one action, by using the following formula (1).

Increased service cost=A incidents×B minutes×C yen (1)
A incidents: number of incidents of pattern (1)+pattern (3) . . . (1)
B minutes: work time of plus-one action
C yen: unit cost of CE

Furthermore, the provisional cost calculating unit 24 calculates the service cost that decreases due to the work that becomes unnecessary by the plus-one action, by using the following formula (2).

Decreased service cost=D incidents×E minutes×C yen (2)
D incidents: number of incidents of pattern (1)
E minutes: travel time and work time that can be reduced by plus-one action

The service cost effectiveness, which is obtained when a preventive action according to plus-one is selected, is provisionally calculated by subtracting the service cost calculated by formula (1) from the service cost calculated by formula (2). For example, when a positive service cost obtained by subtracting the service cost calculated by formula (1) from the service cost calculated by formula (2), the corresponding failure prediction model is adopted as being profitable.

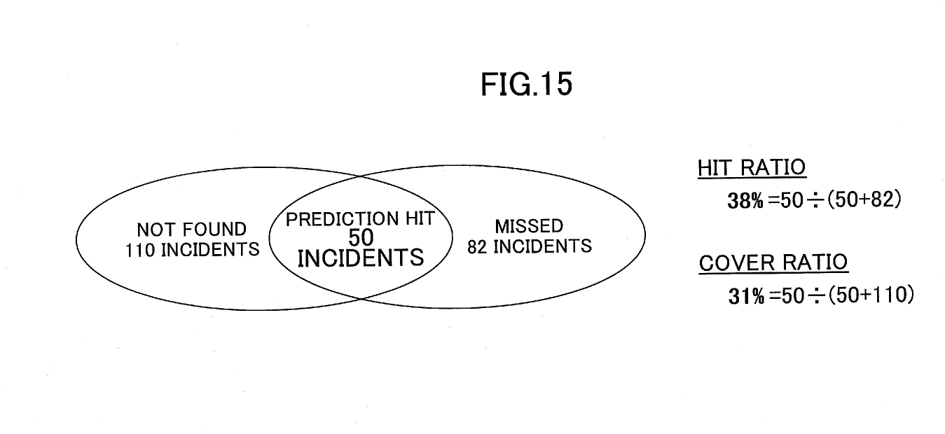

FIG. 15 is a diagram illustrating an example of a result of provisionally calculating the service cost effectiveness when a preventive action according to plus-one is selected, according to the first embodiment of the present disclosure. In FIG. 15, 50 incidents are classified in prediction hit, 82 incidents are classified in missed, and 110 incidents are classified in not found. In FIG. 15, the failure prediction logic is that a failure (error A) is likely to occur when the current output value of a sensor A becomes higher than or equal to a predetermined value. Note that it is assumed that the precision of the failure prediction logic is that a failure of an error A will occur within 30 days at a probability of 38%. Furthermore, the plus-one action is assumed to be wiping the sensor A with water, in order to prevent a failure that is caused by the soiling of the sensor A.

In the example of FIG. 15, the hit ratio is 38% and the cover ratio is 31%. For example, in the example of FIG. 15, when a calculation is made assuming that plus-one action is possible for half “25 incidents” of the incidents of prediction hit, the decrease in the service cost by the plus-one action is less than the increase in the service cost according to the plus-one action for the 82 incidents of missed.

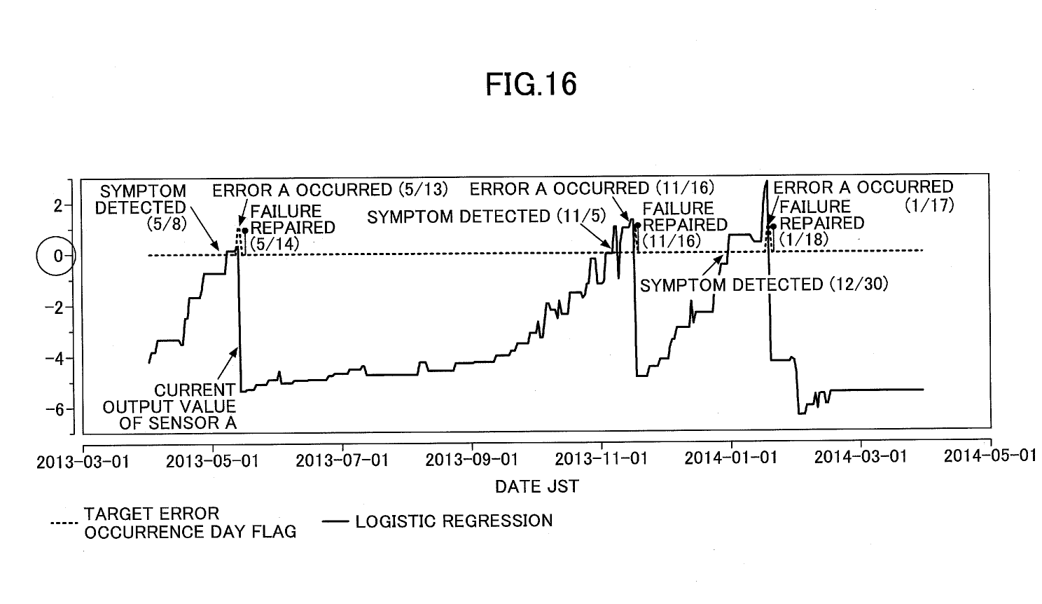

FIG. 16 is a graph illustrating an example of variations of the current output value of the sensor A, according to the first embodiment of the present disclosure. As illustrated in FIG. 16, after the current output value of the sensor A becomes higher than or equal to a predetermined value (symptom detected), a failure (error A) occurs. Therefore, by wiping the sensor A with water according to a plus-one action before the failure (error A) occurs, it is possible to prevent the need for an emergency visit due to the occurrence of the failure (error A).

Furthermore, the provisional cost calculating unit 24 provisionally calculates the service cost effectiveness in the case of an emergency visit, as follows. When components need to be replaced in an emergency visit, by arranging for components before making the emergency visit, it is possible to reduce the need for a revisit that is caused by a shortage in components at the time of the emergency visit. The provisional cost calculating unit 24 can provisionally calculate the service cost effectiveness of the decrease in the ratio of revisits due to shortages in components. When the decrease in service costs, which is caused by the decrease in the ratio of revisits due to shortages in components, is higher than the increase in the service cost due to missed predictions, the preventive action determining unit 43 adopts the corresponding failure prediction model as being profitable.

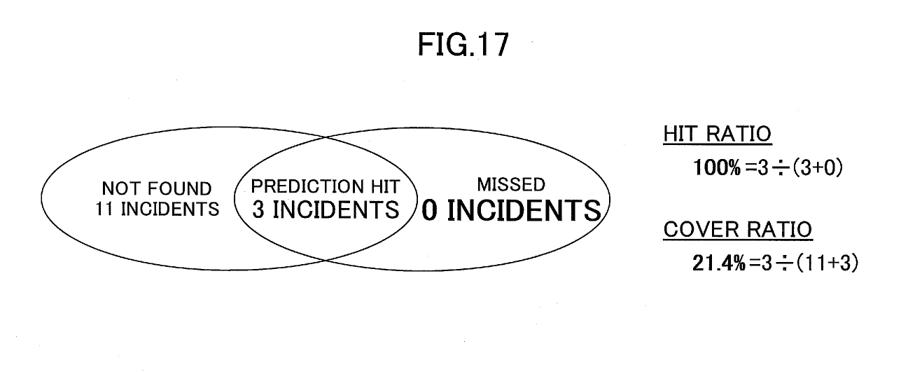

FIG. 17 is a diagram illustrating an example of a result of provisionally calculating the service cost effectiveness in the case of an emergency visit, according to the first embodiment of the present disclosure. In FIG. 17, 3 incidents are classified in prediction hit, zero incidents are classified in missed, and 11 incidents are classified in not found. In FIG. 17, the failure prediction logic is that a failure (error C) will occur when the present value of the current output value of a sensor B rises, and the present value of the developing Y toner density decreases and the toner density decreases.

Note that the precision of the failure prediction logic is that a failure of an error C will occur at a probability of 100%. Furthermore, the work instruction to the CE in an emergency visit is assumed to be to replace the toner supply unit.

In the example of FIG. 17, the hit ratio is 100% and the cover ratio is 21.4%. For example, in the example of FIG. 17, a calculation is made assuming that emergency visits are possible for “three incidents” in prediction hit. A failure of the error C has a high revisit ratio, and therefore the service cost that decreases by the decrease in the revisit ratio, is calculated as the service cost effectiveness in the case of an emergency visit.

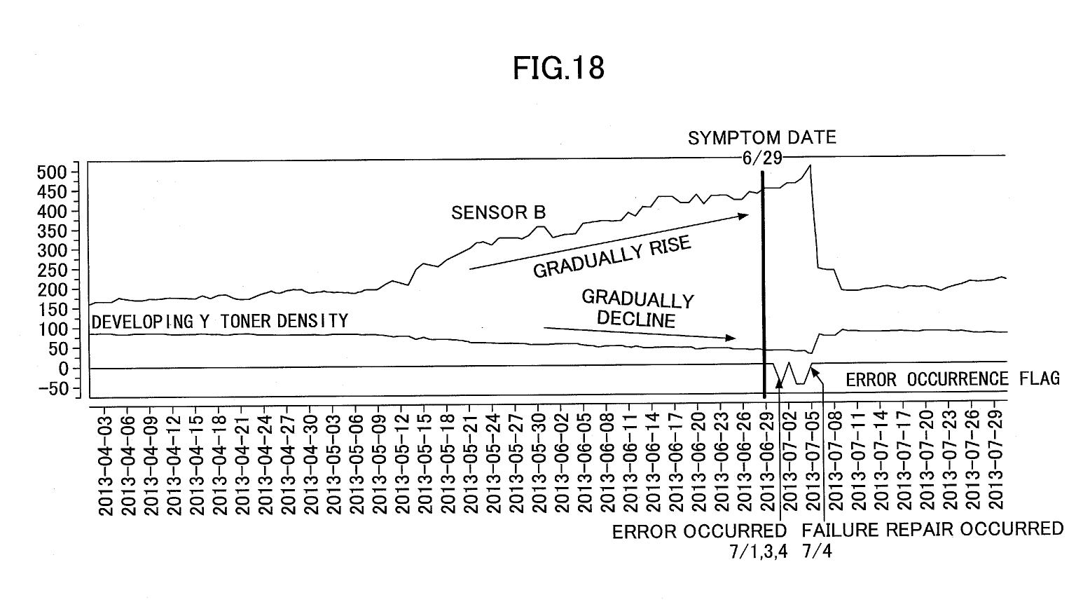

FIG. 18 is a diagram illustrating an example of variations of the current output value of the sensor B and the developing Y toner density, according to the first embodiment of the present disclosure. As illustrated in FIG. 18, after the current output value of the sensor B becomes higher than or equal to a predetermined value and the developing Y toner density becomes less than or equal to a predetermined value (symptom detected), a failure (error C) occurs. By replacing the toner supply unit by an emergency visit before the failure (error C) occurs, it is possible to prevent the need for an emergency visit due to the occurrence of the failure (error C).

Furthermore, the provisional cost calculating unit 24 may use a cause diagnosis model to provisionally calculate the service cost effectiveness in the case of an emergency visit, as follows. The service cost that decreases by a cause diagnosis model includes the time of diagnosing the cause of the failure, the recovery action time, and the travel time for revisiting.

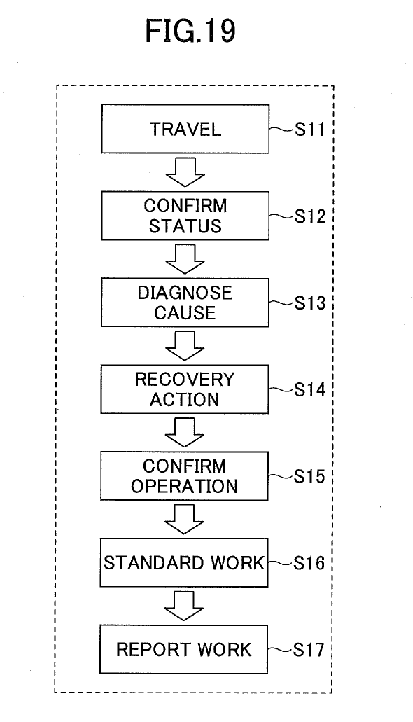

FIG. 19 is a flowchart illustrating an example of an action flow by the CE in the case of an emergency visit, according to the first embodiment of the present disclosure. In step S11, the CE travels to make the emergency visit. In step S12, the CE confirms the status of the device 20. In step S13, the CE diagnoses the cause of the failure by a cause diagnosis model. In step S14, the CE performs a recovery action based on the result of diagnosing the cause of the failure.

In step S15, the CE confirms the operations of the device 20. Furthermore, in step S16, the CE performs standard work such as cleaning. In step S17, the CE sends a work report, and the action flow of FIG. 19 is ended.

By diagnosing the cause of the failure by a cause diagnosis model before the emergency visit, and reporting the result of diagnosing the cause of the failure and required components to the CE before the emergency visit, in the action flow of FIG. 19, the time taken for diagnosing the cause of the failure in step S13 and the time taken for the recovery action in step S14 can be reduced. Furthermore, in the action flow of FIG. 19, the travel time required for a revisit due to a shortage in components can be eliminated.

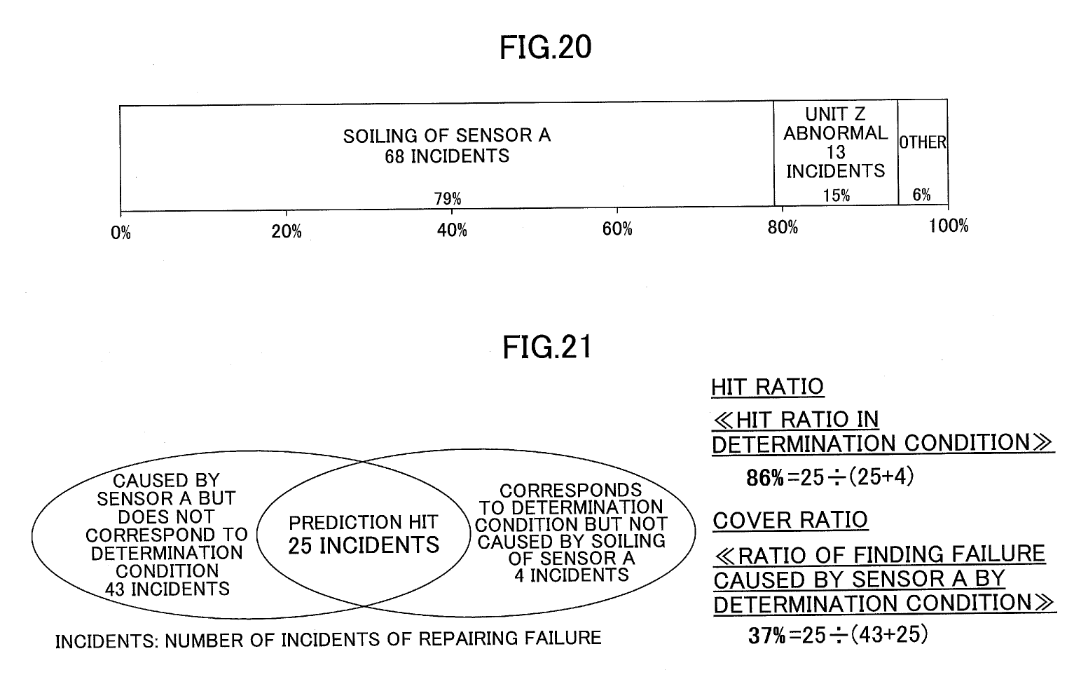

FIG. 20 is a diagram illustrating an example of the cause of a failure (error B), according to the first embodiment of the present disclosure. According to FIG. 20, the main cause of the failure (error B) can be determined to be the “soiling of the sensor A”. Therefore, a cause diagnosis model for the failure (error B) caused by the “soiling of the sensor A” is considered.

For example, the soiling of the sensor A is suspected when a predetermined sensor light amount is higher than or equal to a predetermined value. Therefore, “predetermined sensor light amount is higher than or equal to predetermined value” is defined as a determination condition. The failure (error B) is classified as illustrated as illustrated in FIG. 21, depending on whether the failure (error B) is caused by the soiling of the sensor A, and whether the failure (error B) corresponds to the determination condition.

FIG. 21 is a diagram illustrating an example of classification of the failure (error B), according to the first embodiment of the present disclosure. In FIG. 21, 25 incidents are classified in prediction hit, 43 incidents are classified as a failure that is caused by the soiling of the sensor A but does not correspond to the determination condition, and 4 incidents are classified as a failure that corresponds to the determination condition but not is not caused by the soiling of the sensor A. In FIG. 21, the hit ratio is 86% and the cover ratio is 37%. The work instruction to the CE is to wipe the sensor A with water.

In the example of FIG. 21, with respect to the 25 incidents of prediction hit among the 68 incidents of the failure (error B) caused by the soiling of the sensor A, the time of diagnosing the cause of the failure of step S13 and the recovery action time of step S14 can be reduced. Furthermore, the travel time required for a revisit due to a shortage in components can be eliminated.

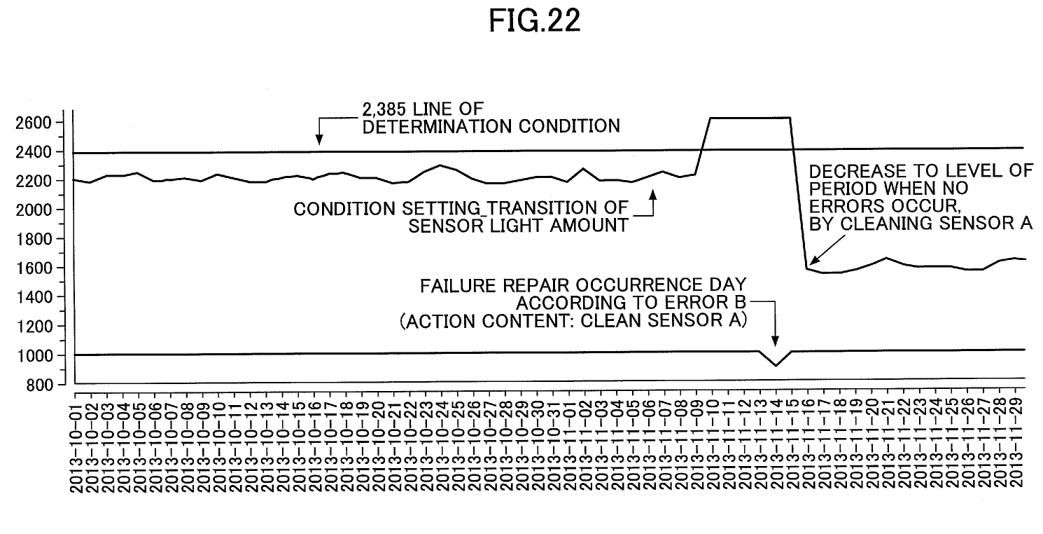

FIG. 22 is a graph illustrating an example of variations in the sensor light amount, according to the first embodiment of the present disclosure. In FIG. 22, after the sensor light amount becomes higher than or equal to a predetermined value (2385) of the determination condition, a failure (error B) occurs. Then, an emergency visit is made and the sensor A is wiped with water. Therefore, the sensor light amount decreases to less than or equal to the predetermined value (2385) of the determination condition.

### Overview of First Embodiment

According to the first embodiment, it is possible to provisionally calculate the service cost involved when a developed failure prediction model is implemented, and to adopt a failure prediction model by which a profit can be obtained. Therefore, according to the present embodiment, it is possible to avoid adopting a failure prediction model that is not profitable and increasing a deficit every time a preventive action is performed.

### Second Embodiment

<Functional Configuration>

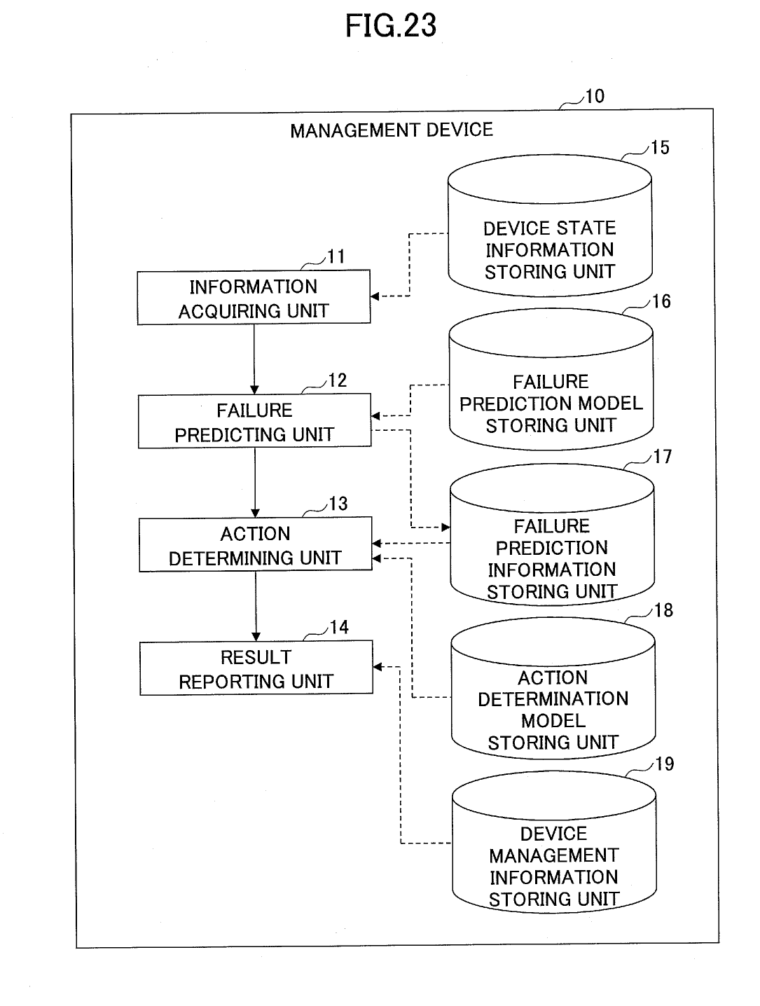

Next, a description is given of a functional configuration of the management device 10 included in the device management system 1 according to a second embodiment, referring to FIG. 23. FIG. 23 is a process block diagram illustrating a functional configuration of an example of the management device 10 according to the second embodiment of the present disclosure.

The management device 10 includes an information acquiring unit 11, a failure predicting unit 12, an action determining unit 13, and a result reporting unit 14. These units are realized by processes that the CPU 106 is caused to execute by one or more programs deployed in the management device 10.

Furthermore, the management device 10 according to the present embodiment includes a device state information storing unit 15, a failure prediction model storing unit 16, a failure prediction information storing unit 17, an action determination model storing unit 18, and a device management information storing unit 19. These storing units may be realized by the HDD 108 or a storage device, etc., connected to the management device 10 via a network N.

The information acquiring unit 11 acquires device state information from the device state information storing unit 15 described below. Here, device state information is information indicating the usage state of the device 20, and includes, for example, measurement values obtained by measuring the current, the voltage, and the temperature, etc., of various components, etc., in the device 20 with various sensors, and a counter value, etc., indicating the frequency of printing print data onto a sheet by the printer 205.

The failure predicting unit 12 predicts that a failure may occur in the device 20, based on the device state information acquired by the information acquiring unit 11 and the failure prediction model stored in the failure prediction model storing unit 16 described below, and generates failure prediction information. Then, the failure predicting unit 12 stores the generated failure prediction information in the failure prediction information storing unit 17.

Here, the failure prediction information is information relevant to a failure that is predicted to occur in the device 20, and includes the probability that the failure will occur, the time until the failure will occur, and the degree of severity of the failure that is predicted to occur, etc.

The action determining unit 13 determines the action content with respect to a failure that is predicted to occur (hereinafter, also referred to as “predicted failure”), based on the failure prediction information stored in the failure prediction information storing unit 17 and an action determination model stored in the action determination model storing unit 18.

Here, for example, the action content according to the present embodiment is classified into four classes of “emergency arrangement”, “inspection (within 3 days)”, “inspection (within 7 days)”, and “provide information”, according to the urgency of the predicted failure. That is, the action content according to the present embodiment is classified into the four classes of “emergency arrangement”, “inspection (within 3 days)”, “inspection (within 7 days)”, and “provide information”, stated in a descending order according to urgency.

The action content “emergency arrangement” is a case that requires to quickly dispatch a CE, etc., to the device 20 in which a failure is predicted, and to perform maintenance work such as replacing components, etc. The action content “inspection (within 3 days)” is a case that requires a CE, etc., to perform inspection within three days with respect to the device 20 in which a failure is predicted. The action content “inspection (within 7 days)” is a case that requires a CE, etc., to perform inspection within seven days with respect to the device 20 in which a failure is predicted. The action content “provide information” is a case in which a failure is predicted but it is not necessarily required to take any action at the present time point.

As described above, in the present embodiment, the management device 10 determines the action content with respect to the predicted failure of the device 20, according to the urgency. Accordingly, with respect to a predicted failure for which the action content is “emergency arrangement”, it is possible to quickly dispatch a CE, etc., and prevent a failure from occurring. On the other hand, with respect to a predicted failure for which the action content is “inspection (within 3 days)” or “inspection (within 7 days)”, the CE, etc., can incorporate the device 20 in which a failure is predicted in a maintenance plan and perform maintenance work within the regular maintenance plan.

The result reporting unit 14 sends a report that a failure is predicted to occur in the device 20, to the terminal device 30 or the terminal device 40, according to the action content determined by the action determining unit 13.

More specifically, when the action content determined by the action determining unit 13 is “emergency arrangement”, the result reporting unit 14 reports to the terminal device 40 that there is a need to quickly dispatch a CE, etc., to the device 20 in which a failure is predicted. At this time, the result reporting unit 14 refers to device management information stored in the device management information storing unit 19 described below, and also reports the contact address, etc., of the CE, etc., who is in charge of the device 20 in which a failure is predicted.

On the other hand, when the action content determined by the action determining unit 13 is “inspection (within 3 days)” or “inspection (within 7 days)”, the result reporting unit 14 reports to the corresponding terminal device 30 that there is a need to perform maintenance work within a maintenance plan. At this time, the result reporting unit 14 refers to device management information stored in the device management information storing unit 19, and also sends this report to the terminal device 30 of the CE, etc., who is in charge of the device 20 in which a failure is predicted.

Furthermore, when the action content determined by the action determining unit 13 is “provide information”, the result reporting unit 14 reports to the corresponding terminal device 30 that a failure is predicted, similar to the case where the action content is “inspection (within 3 days)” or “inspection (within 7 days)”.

The device state information storing unit 15 stores device state information 151. The failure prediction information storing unit 17 stores failure prediction information 171. The device management information storing unit 19 stores device management information 191. Details of the device state information 151, the failure prediction information 171, and the device management information 191 are described below.

The failure prediction model storing unit 16 stores a failure prediction model for predicting a failure in the device 20, based on the device state information 151. A failure prediction model is data formed by modeling patterns of measurement values and counter values when a failure occurs, etc., and there is a failure prediction model for each type of failure (failure type). For example, the failure prediction model storing unit 16 stores a failure prediction model A for predicting a failure A, a failure prediction model B for predicting a failure B, and a failure prediction model C for predicting a failure C, etc.

The action determination model storing unit 18 stores an action determination model 181 for determining the action content based on the failure prediction information 171.

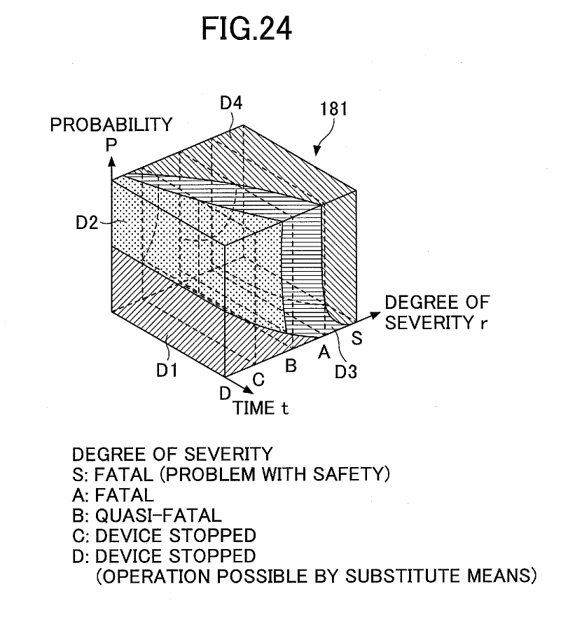

Here, a description is given of the action determination model 181 stored in the action determination model storing unit 18, referring to FIG. 24. FIG. 24 is a perspective view of an example of the action determination model 181 according to the second embodiment of the present disclosure.

As illustrated in FIG. 24, the action determination model 181 is three-dimensional data expressed by three variables of a probability p that a failure will occur, a time t until a failure will occur, and a degree of severity r. Furthermore, the action determination model 181 is divided into the four areas of an area D1, an area D2, an area D3, and an area D4. The action determining unit 13 described above determines the action content according to the area to which the failure prediction information 171 belongs, among the area D1 through the area D4 of the action determination model 181. The failure prediction information 171 also includes a probability p, a time t, and a degree of severity r.

That is, when the failure prediction information 171 belongs to the area D1, the action determining unit 13 determines that the action content is “provide information”. Furthermore, when the failure prediction information 171 belongs to the area D2, the action determining unit 13 determines that the action content is “inspection (within 7 days)”.

Furthermore, when the failure prediction information 171 belongs to the area D3, the action determining unit 13 determines that the action content is “inspection (within 3 days)”. Furthermore, when the failure prediction information 171 belongs to the area D4, the action determining unit 13 determines that the action content is “emergency arrangement”.

Here, in the present embodiment, the degree of severity of the predicted failure is classified into the five degrees of “S”, “A”, “B”, “C”, and “D”.

For example, a predicted failure having a degree of severity “S” is a failure posing a safety issue, when the predicted failure actually occurs.

For example, a predicted failure having a degree of severity “A” is a failure that does not pose a safety issue but the usage of the device 20 becomes impossible, when the predicted failure actually occurs.

For example, a predicted failure having a degree of severity “B” is a failure that requires a long time to repair to repair the device 20 until usage of the device 20 becomes possible, or a failure that requires a high cost (cost of component) to repair the device 20 until usage of the device 20 becomes possible, when the predicted failure actually occurs.

For example, a predicted failure having a degree of severity “C” is a failure by which the usage of the device 20 becomes impossible, but the usability of the device 20 may be restored by changing the setting values or updating the software, etc., when the predicted failure actually occurs.

For example, a predicted failure having a degree of severity “D” is a failure by which the usage of the device 20 can be continued by a substitute means, when the predicted failure actually occurs.

That is, the degrees of severity are defined as “S” through “D” in a descending order according to the seriousness of the failure when the predicted failure actually occurs.

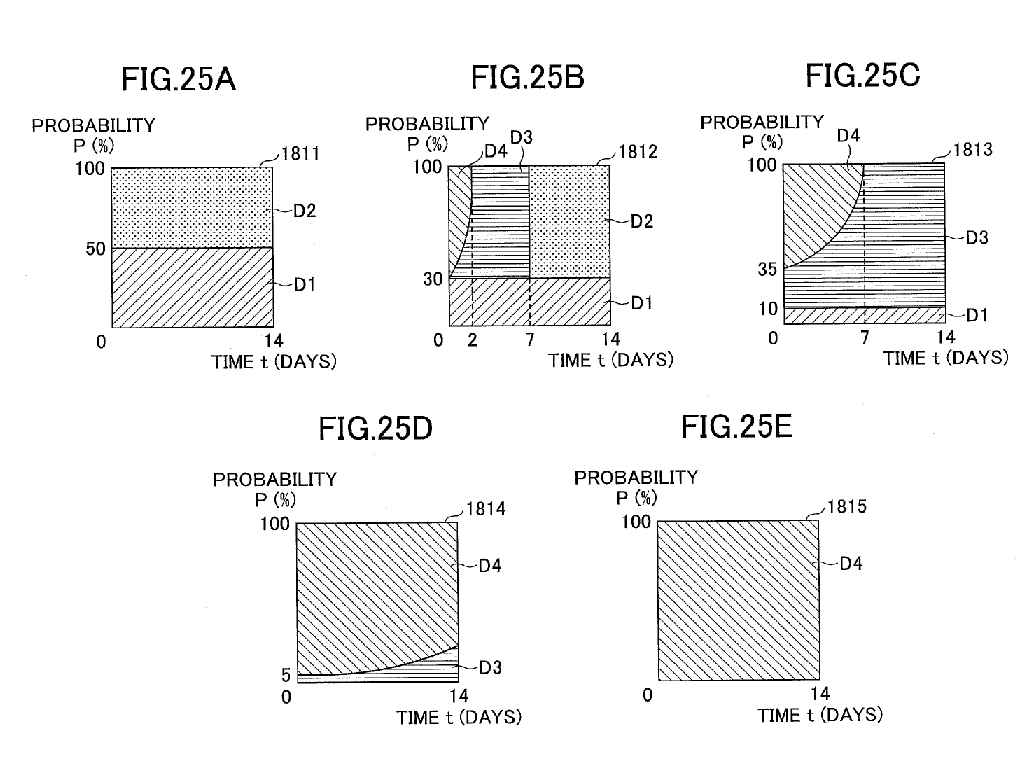

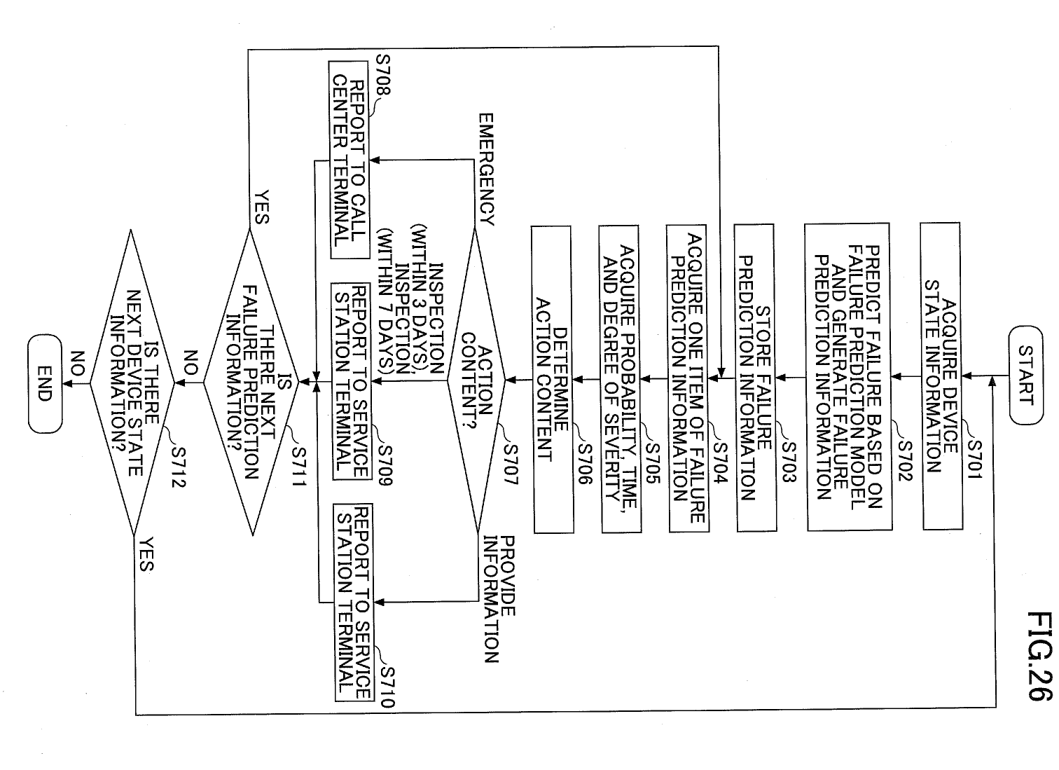

Here, FIGS. 25A through 25E are diagrams respectively illustrating action determination models 1811 through 1815, expressing the action determination model 181 illustrated in FIG. 24 as two-dimensional data including the probability p and the time t, according to the degree of severity r. FIGS. 25A through 25E are a cross-sectional views of examples of the action determination model 181 according to the second embodiment of the present disclosure. Note that in the present embodiment, a description is given assuming that the time t may be a value that is higher than or equal to zero days and less than or equal to 14 days.

The action determination model 1811 illustrated in FIG. 25A indicates two-dimensional data including the probability p and the time t at the degree of severity “D” in the action determination model 181. Therefore, when the degree of severity included in the failure prediction information 171 is “D”, and the probability that the predicted failure will occur is less than 50%, the failure prediction information 171 belongs to the area D1. On the other hand, when the probability that the predicted failure will occur is higher than or equal to 50%, the failure prediction information 171 belongs to the area D2.

The action determination model 1812 illustrated in FIG. 25B indicates two-dimensional data including the probability p and the time t at the degree of severity “C” in the action determination model 181. Therefore, similar to the above, according to the values of the probability p and the time t included in the failure prediction information 171, the failure prediction information 171 belongs to one of the areas of the area D1 through the area D4.

The action determination model 1813 illustrated in FIG. 25C indicates two-dimensional data including the probability p and the time t at the degree of severity “B” in the action determination model 181. Therefore, similar to the above, according to the values of the probability p and the time t included in the failure prediction information 171, the failure prediction information 171 belongs to one of the areas of the area D1, the area D3, or the area D4.

The action determination model 1814 illustrated in FIG. 25D indicates two-dimensional data including the probability p and the time t at the degree of severity “A” in the action determination model 181. Therefore, similar to the above, according to the values of the probability p and the time t included in the failure prediction information 171, the failure prediction information 171 belongs the area D3 or the area D4.

The action determination model 1815 illustrated in FIG. 25E indicates two-dimensional data including the probability p and the time t at the degree of severity “S” in the action determination model 181. Therefore, in this case, the failure prediction information 171 belongs the area D4.

Note that, for example, the administrator, etc., of the device management system 1 may be able to change the boundaries between the areas in the action determination model 1811. For example, in the action determination model 181 illustrated in FIG. 25A, the value indicating the boundary between the area D1 and the area D2 is a probability p=50%; however, the value indicating the boundary may be changed. Accordingly, for example, the administrator, etc., of the device management system 1 can adjust the action content to be determined according to the predicted failure.

Furthermore, the example of the action determination model 181 illustrated in FIG. 24 is divided into four areas of the area D1 through the area D4; however, the areas are not so limited, and the action determination model 181 may be divided into any number of areas. That is, for example, the action determination model 181 may be divided into five areas of the area D1 through the area D5. The area D1 may the area where the action content is determined to be “provide information”, the area D2 may the area where the action content is determined to be “inspection (within 14 days)”, the area D3 may the area where the action content is determined to be “inspection (within 7 days)”, the area D4 may the area where the action content is determined to be “inspection (within 3 days)”, and the area D5 may the area where the action content is determined to be “emergency arrangement”.

Accordingly, for example, the administrator, etc., of the device management system 1 is able to set the action content according to the number of areas. At this time, for example, the administrator, etc., of the device management system 1 may be able to set any time period until inspection is to be performed. That is, for example, the administrator, etc., may be able to set any value as N in “inspection (within N days)”.

<Details of Process>

Next, a description is given of details of a process performed by the device management system 1 according to the second embodiment, referring to FIG. 26. FIG. 26 is a flowchart of an example of a process of determining the action content according to the second embodiment of the present disclosure.

First, the information acquiring unit 11 of the management device 10 acquires the device state information 151 of one of the devices 20, from the device state information storing unit 15 (step S701).

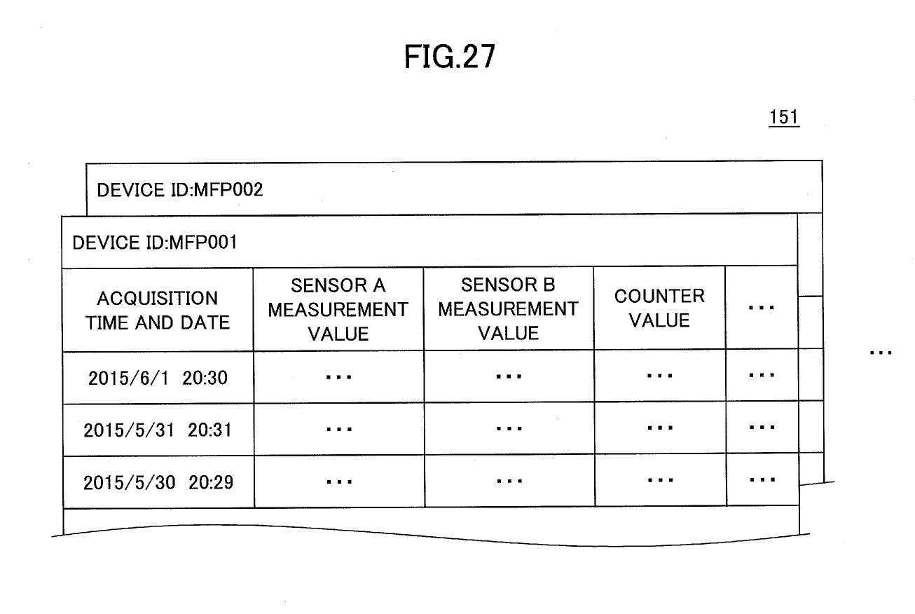

Here, a description is given of the device state information 151 stored in the device state information storing unit 15, referring to FIG. 27. FIG. 27 is a diagram illustrating an example of the device state information 151 according to the second embodiment of the present disclosure.

As illustrated in FIG. 27, the device state information 151 is stored in the device state information storing unit 15, for each device ID uniquely identifying the device 20. That is, the device state information storing unit 15 stores the device state information 151 for the device ID “MFP001” and the device state information 151 for the device ID “MFP002”, etc.

Furthermore, the device state information 151 includes an acquisition time and date, a measurement value of the sensor A, a measurement value of the sensor B, and a counter value, etc., as data items. That is, in the device state information 151, measurement values obtained by measuring the current, the voltage, and the temperature, etc., of various components, etc., in the device 20 with various sensors, and a counter value, etc., indicating the frequency of printing print data onto a sheet by the printer 205, are associated with the date and time of acquiring the measurement values and the counter value, etc., from the device 20. As described above, the device state information 151 is information indicating the history of the measurement values and the counter value, etc., of the device 20 at predetermined intervals.

Next, the failure predicting unit 12 of the management device 10 predicts a failure in the device 20 based on the device state information 151 and the failure prediction model stored in the failure prediction model storing unit 16, and generates the failure prediction information 171 (step S702).

That is, for example, in step S701, when the device state information 151 of the device ID “MFP001” is acquired, the failure predicting unit 12 predicts that a failure A will occur, based on the device state information 151 and the failure prediction model A for predicting a failure A. Similarly, the failure predicting unit 12 predicts that a failure B will occur, based on the device state information 151 and the failure prediction model B for predicting a failure B. As described above, the failure predicting unit 12 predicts that a failure corresponding to a failure prediction model will occur, for each failure prediction model stored in the failure prediction model storing unit 16. Then, the failure predicting unit 12 generates the failure prediction information 171 based on these prediction results.

Next, the failure prediction unit 12 of the management device 10 stores the failure prediction information 171 generated in step S702 in the failure prediction information storing unit 17 (step S703).

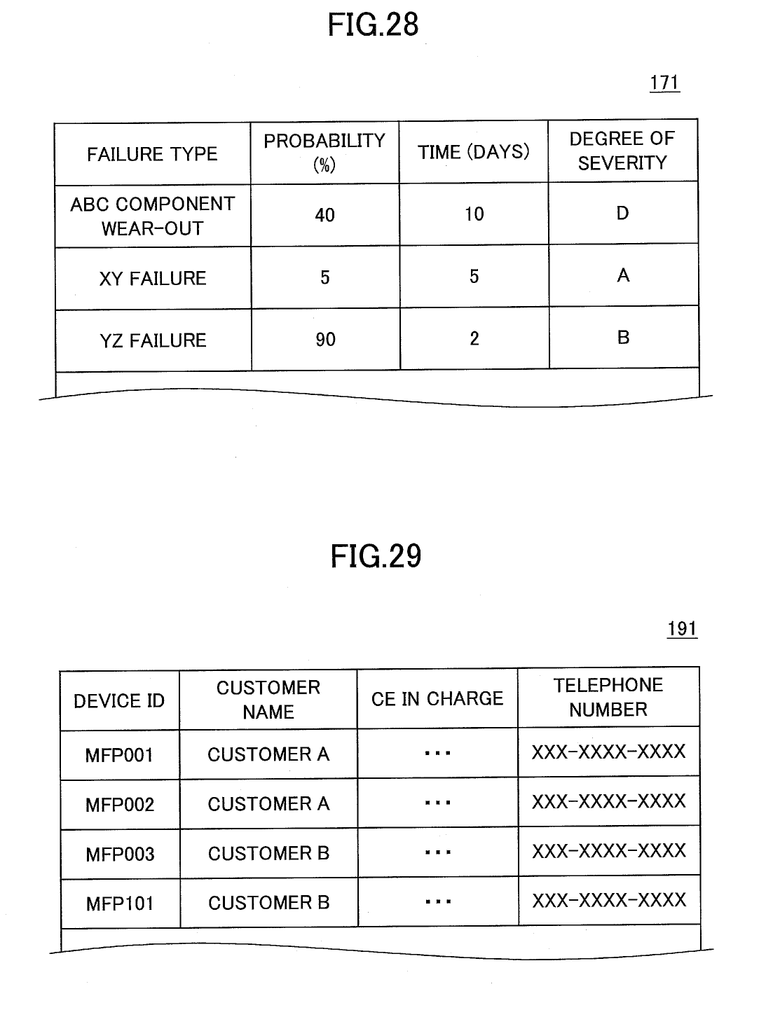

Here, a description is given of the failure prediction information 171 stored in the failure prediction information storing unit 17, referring to FIG. 28. FIG. 28 is a diagram illustrating an example of the failure prediction information 171 according to the second embodiment of the present disclosure.

As illustrated in FIG. 28, the failure prediction information 171 includes failure type, probability, time, and degree of severity, as data items. The failure type is the type of the failure corresponding to the failure prediction model. The probability is the probability that a predicted failure will occur. The time is the time (period) until a predicted failure occurs. The degree of severity is the degree of severity of the predicted failure.

For example, in the first failure prediction information 171 stored in the failure prediction information storing unit 17, the failure type is “ABC component wear-out”, the probability is “40%”, the time is “10 days”, and the degree of severity is “D”. This information indicates that this failure prediction information 171 is the prediction result of the failure prediction model for predicting that the failure of failure type “ABC component wear-out” will occur, and indicates that a failure “ABC component wear-out” having a degree of severity “D” will occur “10 days” later at a probability of “40%”.

Similarly, in the second failure prediction information 171 stored in the failure prediction information storing unit 17, the failure type is “XY failure”, the probability is “5%”, the time is “5 days”, and the degree of severity is “A”. This information indicates that this failure prediction information 171 is the prediction result of the failure prediction model for predicting that the failure of failure type “XY failure” will occur, and this information indicates that a failure “XY failure” having a degree of severity “A” will occur “5 days” later at a probability of “5%”.

Next, the action determining unit 13 of the management device 10 acquires one failure prediction information item 171 from the failure prediction information storing unit 17 (step S704).

Next, the action determining unit 13 of the management device 10 acquires the probability, the time, and the degree of severity from the acquired failure prediction information 171 (step S705).

Next, the action determining unit 13 of the management device 10 determines the action content corresponding to the predicted failure, based on the acquired probability, time, and degree of severity, and the action determination model 181 (step S706).

That is, the action determining unit 13 identifies a model corresponding to the acquired degree of severity, from among the action determination model 1811 illustrated in FIG. 25A through the action determination model 1815 illustrated in FIG. 25E, according to the degree of severity. Then, the action determining unit 13 identifies the area to which the failure prediction information 171 belongs in the identified model based on the probability and the time, and determines the action content corresponding to the identified area.

For example, when the first failure prediction information item 171 is acquired from the failure prediction information storing unit 17 in step S704, the action determining unit 13 identifies the action determination model 1811 having the degree of severity “D”. Then, the action determining unit 13 identifies the area D1 as the area to which the failure prediction information 171 belongs in the action determination model 1811, based on the probability “40%” and the time “10 days”. Therefore, in this case, the action determining unit 13 determines the action content to be “provide information”.

Similarly, when the second failure prediction information item 171 is acquired from the failure prediction information storing unit 17 in step S704, the action determining unit 13 identifies the action determination model 1814 having the degree of severity “A”. Then, the action determining unit 13 identifies the area D3 as the area to which the failure prediction information 171 belongs in the action determination model 1814, based on the probability “5%” and the time “5 days”. Therefore, in this case, the action determining unit 13 determines the action content to be “inspection (within 3 days)”.

Similarly, when the third failure prediction information item 171 is acquired from the failure prediction information storing unit 17 in step S704, the action determining unit 13 identifies the action determination model 1813 having the degree of severity “B”. Then, the action determining unit 13 identifies the area D4 as the area to which the failure prediction information 171 belongs in the action determination model 1813, based on the probability “90%” and the time “2 days”. Therefore, in this case, the action determining unit 13 determines the action content to be “emergency arrangement”.

Next, the action determining unit 13 of the management device 10 determines whether the action content determined in step S706 is “emergency arrangement”, “inspection (within 3 days)”, “inspection (within 7 days)”, or “provide information” (step S707).

In step S707, when the action determining unit 13 determines that the action content is “emergency arrangement”, the result reporting unit 14 of the management device 10 reports that a failure for which the action content is “emergency arrangement”, has been predicted, to the terminal device 40 (step S708). At this time, the result reporting unit 14 acquires information such as the name of the customer where the device 20 in which a failure has been predicted is deployed, the CE in charge of maintenance of the device 20, and the telephone number of the CE in charge, etc., from the device management information 191 stored in the device management information storing unit 19.

Here, a description is given of the device management information 191 stored in the device management information storing unit 19, referring to FIG. 29. FIG. 29 is a diagram illustrating an example of the device management information 191 according to the second embodiment of the present disclosure.

As illustrated in FIG. 29, the device management information 191 includes device ID, customer name, CE in charge, and telephone number, as data items. Accordingly, the customer name of the customer environment in which the device 20 indicated by the device ID is deployed, the CE in charge of maintenance of the device 20, and the telephone number of the CE in charge, etc., are managed. Note that as the CE in charge, a plurality of CEs, etc., may be set, or an assistant CE in charge may be set in addition to the CE in charge.

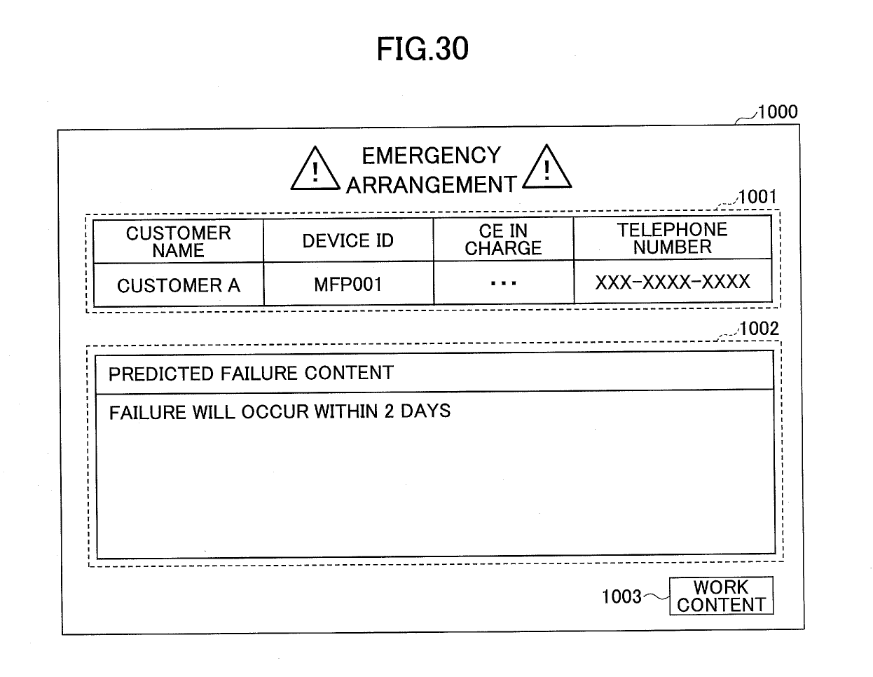

As described above, the terminal device 40 that has received a report from the result reporting unit 14 of the management device 10 in step S708 displays, for example, an emergency arrangement screen 1000 as illustrated in FIG. 30. FIG. 30 is a diagram illustrating an example of the emergency arrangement screen 1000 according to the second embodiment of the present disclosure.

In the emergency arrangement screen 1000 illustrated in FIG. 30, the name of the customer where the device 20 in which a failure is predicted is deployed, the device ID of the device 20, the CE in charge of the device 20, and the telephone number of the CE in charge, etc., are displayed in a display area 1001. Furthermore, in the emergency arrangement screen 1000 illustrated in FIG. 30, the contents of the predicted failure are displayed in a display area 1002. Accordingly, the operator, etc., at a call center is able to instruct the CE in charge displayed on the display area 1001, to quickly go to the customer and perform maintenance work.

Furthermore, in the emergency arrangement screen 1000 illustrated in FIG. 30, when the operator, etc., presses a work content button 1003, the screen may transition to a work content screen of maintenance work with respect to the predicted failure. In the work content screen, information such as components needed for repairing the predicted failure, etc., is displayed. Accordingly, the operator, etc., is able to present the information such as components needed for the maintenance work, to the CE in charge.

In step S707, when the action determining unit 13 determines that the action content is “inspection (within 3 days)” or “inspection (within 7 days)”, the result reporting unit 14 reports to the corresponding terminal device 30 that a failure is predicted (step S709). That is, the result reporting unit 14 refers to the device management information 191, and reports that a failure for which the action content is “inspection (within 3 days)” or “inspection (within 7 days)” is predicted, to the terminal device 30 of the CE in charge of the device 20 in which the failure is predicted.

According to the above, at the terminal device 30 that has received the report from the result reporting unit 14 of the management device 10 in step S709, a maintenance plan screen is displayed.

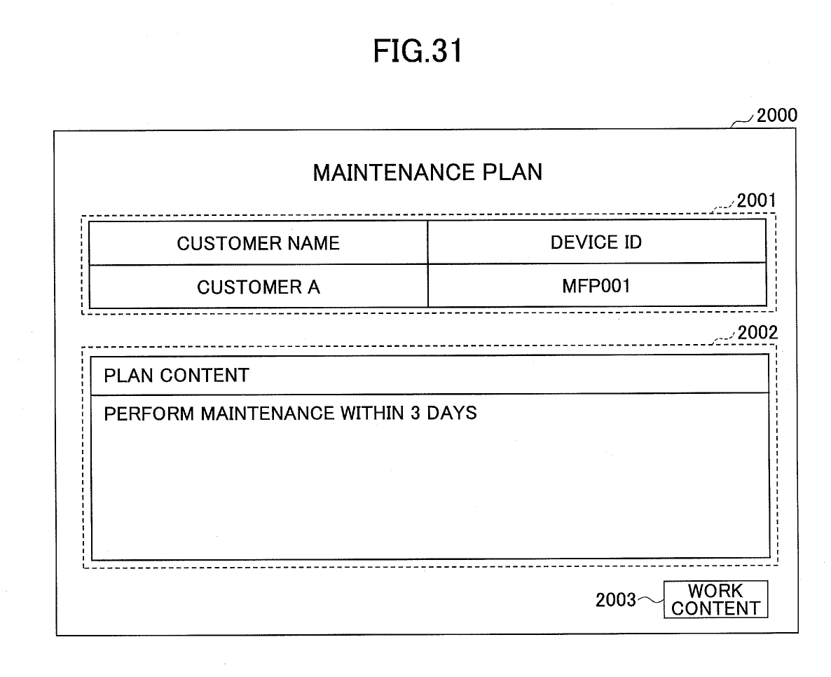

Here, FIG. 31 is a diagram illustrating an example of a maintenance plan screen displayed at the terminal device 30, when a failure for which the action content is “inspection (within 3 days)” is predicted. FIG. 31 illustrates an example of a maintenance plan screen according to the second embodiment of the present disclosure.

In a maintenance plan screen 2000 illustrated in FIG. 31, the name of the customer where the device 20 in which a failure is predicted is deployed, and the device ID of the device 20, are displayed in a display area 2001. Furthermore, in the maintenance plan screen 2000 illustrated in FIG. 31, the contents of the maintenance plan are displayed in a display area 2002. Accordingly, the CE, etc., is able to perform maintenance work with respect to the device 20 that is the maintenance target, according to contents displayed in the maintenance plan screen 2000.

Furthermore, in the maintenance plan screen 2000 illustrated in FIG. 31, when the CE, etc., presses a work content button 2003, the screen may transition to a work content screen of the maintenance work with respect to the predicted failure. In the work content screen, information of components, etc., needed for repairing the predicted failure is displayed. Accordingly, the CE, etc., is able to recognize the information of components, etc., needed for the maintenance work.

In step S707, when the action determining unit 13 determines that the action content is “provide information”, the result reporting unit 14 reports to the corresponding terminal device 30 that a failure is predicted (step S710). That is, the result reporting unit 14 refers to the device management information 191, and reports to the terminal device 30, which is used by the CE in charge of the device 20 in which the failure is predicted, that a failure having the action content of “provide information” has been predicted.

Here, the content that is reported to the terminal device 30 as “provide information” may include, for example, the content of maintenance work for preventing the predicted failure and the estimated work time of the maintenance work, etc., in addition to a report that a failure is predicted. Accordingly, the CE in charge is able to determine whether to perform the maintenance work, in view of the probability that the predicted failure will occur and the work time required for preventing the predicted failure from occurring, etc. That is, for example, the CE in charge is able to determine whether to perform the maintenance work in view of the time and cost required when the predicted failure actually occurs, and the time and cost required for the maintenance work to prevent the predicted failure from occurring.

Note that in step S710, the result reporting unit 14 does not have to send a report. That is, the result reporting unit 14 may not report the information, which is relevant to a predicted failure that does not need to be handled, to the CE in charge. Accordingly, at the terminal device 30 of the CE in charge, information relevant to a predicted failure that is not necessarily required to be handled, is not displayed.

Next, the action determining unit 13 of the management device 10 determines whether there is next failure prediction information 171 in the failure prediction information storing unit 17 (step S711).

In step S711, when the action determining unit 13 determines that there is next failure prediction information 171, the action determining unit 13 returns to step S704. In this case, in step S704, the action determining unit 13 acquires the next failure prediction information 171 from the failure prediction information storing unit 17.

In step S711, when the action determining unit 13 determines that there is no next failure prediction information 171, the information acquiring unit 11 determines whether there is next device state information 151 (that is, the device state information 151 of the next device ID) (step S712).

In step S712, when the information acquiring unit 11 determines that there is next device state information 151, the information acquiring unit 11 returns to step S701. In this case, in step S701, the information acquiring unit 11 acquires the next device state information 151 from the device state information storing unit 15.

In step S712, when the information acquiring unit 11 determines that there is no next device state information 151, the management device 10 ends the process.

As described above, in the device management system 1 according to the present embodiment, the action content for the predicted failure is determined according to the degree of severity of the predicted failure in the device 20.

Furthermore, in the device management system 1 according to the present embodiment, when the action content needs to be quickly implemented (that is, in the case of “emergency arrangement”), a report is sent to the call center and a CE in charge is dispatched to the device 20. Accordingly, in the device management system 1 according to the present embodiment, the CE, etc., can quickly perform appropriate maintenance work, and a predicted failure having a high degree of severity and a predicted failure having a high probability of occurrence, etc., are prevented from actually occurring.

Furthermore, in the device management system 1 according to the present embodiment, when the action content does not necessarily need to be quickly implemented (that is, in a case of “inspection (within 3 days)” or “inspection (within 7 days)”), a report indicating that maintenance work needs to be performed within the maintenance plan, is sent to the CE in charge. Accordingly, in the device management system 1 according to the present embodiment, maintenance work can be performed within the regular maintenance plan with respect to a predicted failure of low urgency.

### Third Embodiment

Next, a description is given of the device management system 1 according to a third embodiment. In the description of the third embodiment, the parts that differ from the second embodiment are described, and the same elements as those of the second embodiment are denoted by the same reference numerals and redundant descriptions are omitted.

In the present embodiment, the action content is adjusted (changed) according to attribute information of a customer who is the user of the device 20. Here, attribute information of the customer is, for example, the business type of the customer, the busy season of the customer, the location of the business place, whether there is a substitute device that can be used when a failure occurs in the device 20, and the group to which the customer belongs, etc.

<Functional Configuration>

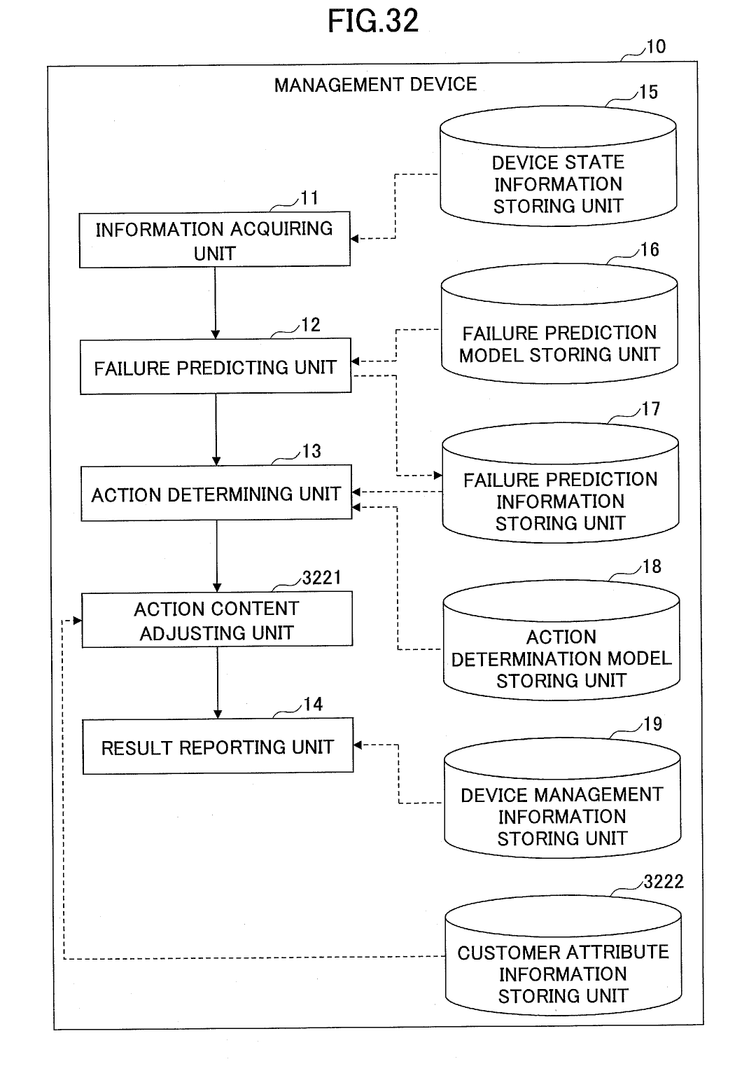

Next, a description is given of a functional configuration of the management device 10 included in the device management system 1 according to the third embodiment, referring to FIG. 32. FIG. 32 is a process block diagram illustrating a functional configuration of an example of the management device 10 according to the third embodiment of the present disclosure.

The management device 10 according to the present embodiment includes an action content adjusting unit 3221. The action content adjusting unit 3221 is realized by processes that the CPU 106 is caused to execute by one or more programs deployed in the management device 10.

Furthermore, the management device 10 according to the present embodiment includes a customer attribute information storing unit 3222. The customer attribute information storing unit 3222 may be realized by the HDD 108 or a storage device, etc., connected to the management device 10 via a network N.

The action content adjusting unit 3221 adjusts (changes) the action content determined by the action determining unit 13, based on customer attribute information stored in the customer attribute information storing unit 3222 described below.

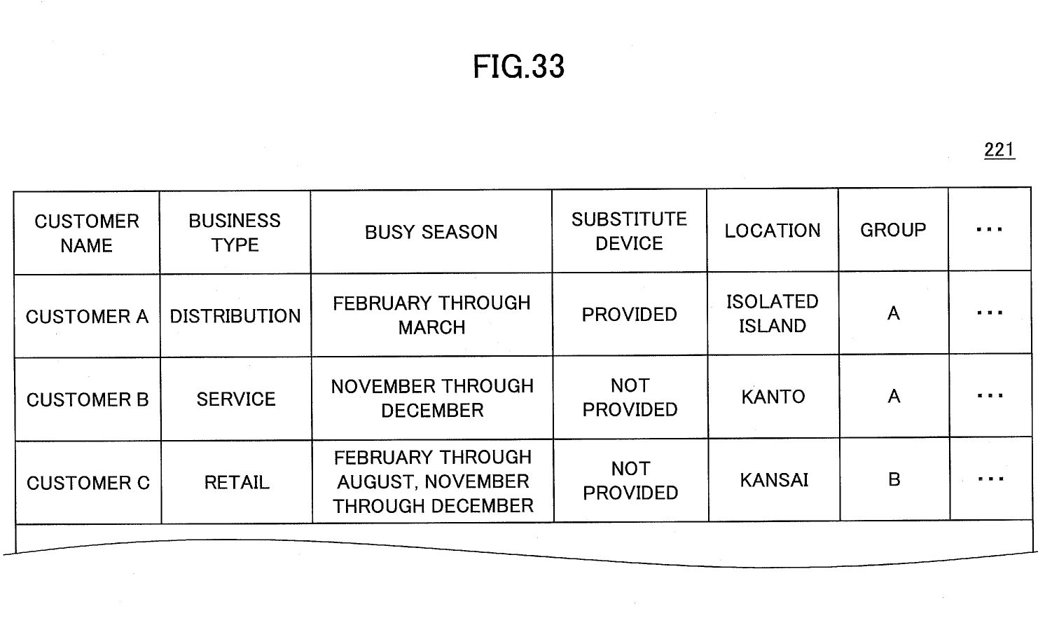

The customer attribute information storing unit 3222 stores customer attribute information 221. Here, a description is given of the customer attribute information 221 stored in the customer attribute information storing unit 3222, referring to FIG. 33. FIG. 33 is a diagram illustrating an example of the customer attribute information 221 according to the third embodiment of the present disclosure.

As illustrated in FIG. 33, the customer attribute information 221 includes customer name, business type, busy season, substitute device, location, and group, etc., as data items.

The customer name is the name of the customer who is the user of the device 20. The business type is the type of the business, etc., operated by the costumer. The busy season is the period in which activities of the business, etc., of the customer are more active than usual. The substitute device indicates whether there is a device 20 that can be used as a substitute device, when a failure occurs in the device 20 deployed in the customer environment of the customer. The location is the location where activities of the business, etc., operated by the customer are held. The group is information for identifying a group, when customers are classified into a plurality of groups according to a predetermined condition.

Note that the action content adjusting unit 3221 may include various data items such as the business scale of the customer and the accumulated number of times a failure has occurred in the device 20 deployed in the customer environment, etc., in addition to the data items indicated in FIG. 33.

<Details of Process>

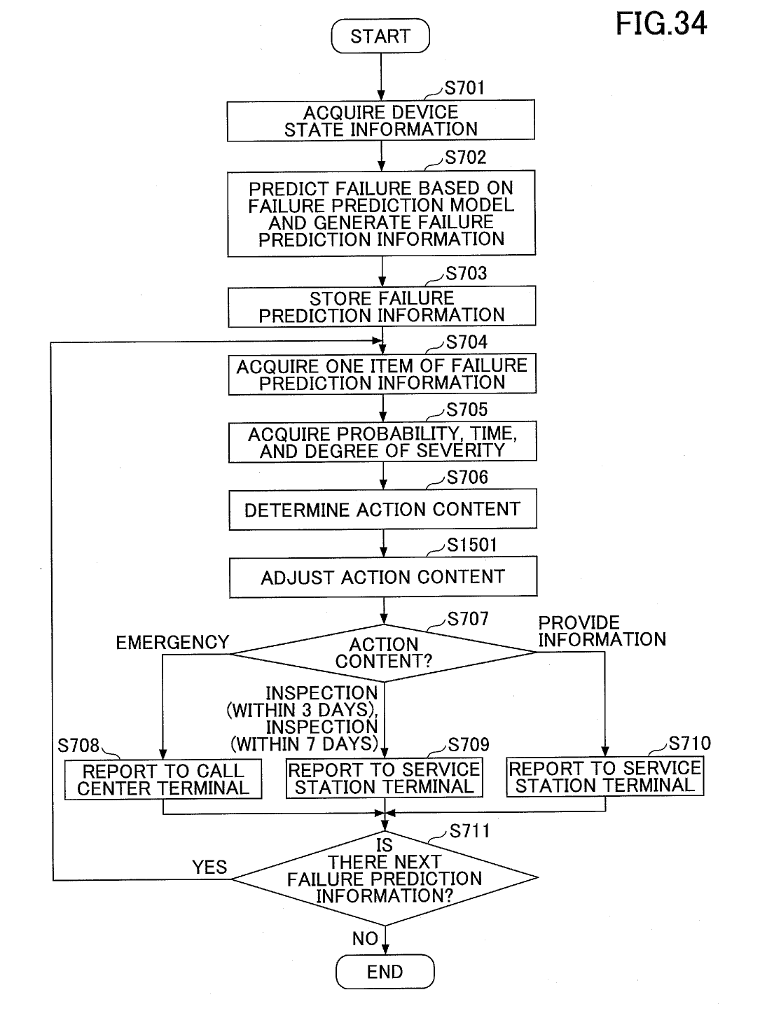

Next, a description is given of details of a process performed by the device management system 1 according to the third embodiment, referring to FIG. 34. FIG. 34 is a flowchart of an example of a process of determining the action content according to the third embodiment of the present disclosure.

The action content adjusting unit 3221 of the management device 10 refers to the customer attribute information 221 stored in the customer attribute information storing unit 3222, and adjusts the action content determined by the action determining unit 13 in step S706 (step S1501).

More specifically, the action content adjusting unit 3221 refers to the customer attribute information 221 of the customer corresponding to the customer environment in which the device 20 in which the failure is predicted is deployed, and adjusts the action content determined by the action determining unit 13. Note that in the next step S707, the action determining unit 13 determines whether the action content adjusted by the action content adjusting unit 3221 is “emergency arrangement”, “inspection (within 3 days)”, “inspection (within 7 days)”, or “provide information”.

Here, for example, the action content adjusting unit 3221 adjusts the action content determined by the action determining unit 13, as follows.

(1) The action content adjusting unit 3221 refers to the “business type” of the customer in the customer attribute information 221, and if the business type is a predetermined business type that is set in advance, the action content adjusting unit 3221 increases the urgency of the action content. For example, when the action content determined by the action determining unit 13 is “inspection (within 7 days)”, and the business type of the customer is “service”, the action content adjusting unit 3221 increases the urgency, and adjusts (changes) the action content to “inspection (within 3 days)”.

(2) The action content adjusting unit 3221 refers to the “busy season” of the customer in the customer attribute information 221, and if the present time corresponds to the busy season of the customer, the action content adjusting unit 3221 increases the urgency of the action content. For example, when the action content determined by the action determining unit 13 is “inspection (within 3 days)”, and the present time corresponds to the busy season of the customer, the action content adjusting unit 3221 increases the urgency, and adjusts (changes) the action content to “emergency arrangement”.

(3) The action content adjusting unit 3221 refers to the “substitute device” of the customer in the customer attribute information 221, and the action content adjusting unit 3221 increases the urgency of the action content according to whether a substitute device has been provided to the customer. For example, when the substitute device is “provided”, the action content adjusting unit 3221 decreases the urgency of the action content determined by the action determining unit 13. On the other hand, when the substitute device is “not provided”, the action content adjusting unit 3221 increases the urgency of the action content determined by the action determining unit 13.

(4) The action content adjusting unit 3221 refers to the “location” of the customer in the customer attribute information 221, and when the location is a predetermined location set in advance, the action content adjusting unit 3221 increases the urgency of the action content.

(5) The action content adjusting unit 3221 refers to the “group” of the customer in the customer attribute information 221, and when the group corresponds to a predetermined group, the action content adjusting unit 3221 changes the urgency of the action content. For example, when the customer belongs to a group “A”, the action content adjusting unit 3221 increases the urgency of the action content determined by the action determining unit 13. On the other hand, when the customer belongs to a group “B”, the action content adjusting unit 3221 decreases the urgency of the action content determined by the action determining unit 13.

As described above, in the device management system 1 according to the present embodiment, the action content is adjusted according to the attribute information of the customer who is the user of the device 20 in which a failure has been predicted. Accordingly, in the device management system 1 according to the present embodiment, appropriate maintenance work can be performed according to the customer.

For example, by classifying a customer, who has entered into a regular lease contract of the device 20, into a group “B”, and by classifying a customer, who has entered into a special maintenance contract in addition to the regular lease contract, into a group “A”, maintenance work can be performed according to action content of increased urgency for the customer of group “A”.

According to one embodiment of the present disclosure, an information processing system is capable of provisionally calculating a cost when a failure prediction model is implemented and determining to adopt a failure prediction model that is profitable.

According to one embodiment of the present disclosure, an information processing system is capable of supporting the process of determining action content according to a predicted failure.

The information processing system and the failure prediction model adoption determining method are not limited to the specific embodiments described in the detailed description, and variations and modifications may be made without departing from the spirit and scope of the present disclosure.

What is claimed is:

1. An information processing system including at least one information processing apparatus, the information processing system comprising:
a provisional cost calculator configured to apply failure history information to a failure prediction model to provisionally calculate a cost of the failure prediction model, the failure history information expressing failure history of at least one electronic device in which a failure has occurred, the failure prediction model including a symptom detection method for detecting a symptom of a failure to occur in the electronic device in association with a preventive action for preventing the failure to occur in the electronic device; and
an adoption determiner configured to determine to adopt the failure prediction model by which a profit can be obtained, based on a result of the provisional calculation.

2. The information processing system according to claim 1, wherein
the provisional cost calculator calculates a cost that increases by implementing the failure prediction model and a cost that decreases by implementing the failure prediction model, and
the adoption determiner determines to adopt the failure prediction model as being profitable, when the cost that decreases by implementing the failure prediction model is higher than the cost that increases by implementing the failure prediction model.

3. The information processing system according to claim 2, wherein the adoption determiner determines to adopt the failure prediction model as being profitable, when the preventive action is performed by incidental work, and a cost of work that becomes unnecessary due to the incidental work is higher than a cost that arises due to the incidental work.

4. The information processing system according to claim 3, wherein the provisional cost calculator provisionally calculates a cost of work corresponding to a number of incidents in which a failure has actually occurred after the symptom of the failure has been detected by the symptom detection method, as the cost of the work that becomes unnecessary due to the incidental work.

5. The information processing system according to claim 2, wherein the adoption determiner determines to adopt the failure prediction model as being profitable, when the preventive action requires visit work to replace a component, and a cost of revisit work that becomes unnecessary is higher than a cost that arises by arranging for the component beforehand.

6. The information processing system according to claim 1, wherein the provisional cost calculator provisionally calculates the cost of the failure prediction model, based on a manpower cost that arises according to a time required for the preventative action and a component cost that arises in the preventative action.

7. The information processing system according to claim 1, further comprising:
an acquirer configured to acquire, from a predetermined storage, state information indicating a state of the at least one electronic device that is coupled to the information processing system via a network;
a failure predictor configured to generate failure prediction information based on the state information acquired by the acquirer and the failure prediction model, the failure prediction information including a probability of the failure occurring in the at least one electronic device, a period until the failure occurs by the probability, and a degree of severity of the failure;
an action content determiner configured to determine action content indicating how to handle the failure that has been predicted, according to the probability, the period, and the degree of severity, based on the failure prediction information generated by the failure predictor; and
a reporter configured to send a report according to the action content determined by the action content determiner.

8. The information processing system according to claim 7, wherein
the failure prediction model includes a plurality of areas, and
the action content determiner uses the failure prediction model to determine the action content, according to an area to which a value belongs among the plurality of areas of the failure prediction model, the value being indicated by the probability, the period, and the degree of severity included in the failure prediction information.

9. The information processing system according to claim 7, further comprising
a changer configured to change the action content according to attribute information of a user of the at least one electronic device, wherein
the changer changes the action content determined by the action content determiner, according to one or more of a business type of the user, a location of a business place of the user, information relating to a busy season of the user, and a group to which the user belongs, which are included in the attribute information.

10. The information processing system according to claim 7, wherein the failure predictor generates the failure prediction information for each failure that is a prediction target, based on the state information and the failure prediction model of each failure that is the prediction target.

11. The information processing system according to claim 7, further comprising
at least one terminal device coupled to the at least one information processing apparatus via the network, wherein
the reporter sends the report to the at least one terminal device.

12. The information processing system according to claim 11, wherein
the at least one terminal device includes a first terminal device disposed in a call center and a second terminal device disposed in a service station, and
the reporter sends the report to the first terminal device or the second terminal device according to the action content.

13. A method for adopting a failure prediction model executed in an information processing system including at least one information processing apparatus, the method comprising:
applying failure history information to a failure prediction model to provisionally calculate a cost of the failure prediction model, the failure history information expressing failure history of at least one electronic device in which a failure has occurred, the failure prediction model including a symptom detection method for detecting a symptom of a failure to occur in the electronic device in association with a preventive action for preventing the failure to occur in the electronic device; and
determining to adopt the failure prediction model by which a profit can be obtained, based on a result of the provisional calculation.

14. A non-transitory computer-readable recording medium storing a program that causes a computer to execute a process performed in an information processing system including at least one information processing apparatus, the process comprising:
applying failure history information to a failure prediction model to provisionally calculate a cost of the failure prediction model, the failure history information expressing failure history of at least one electronic device in which a failure has occurred, the failure prediction model including a symptom detection method for detecting a symptom of a failure to occur in the electronic device in association with a preventive action for preventing the failure to occur in the electronic device; and
determining to adopt the failure prediction model by which a profit can be obtained, based on a result of the provisional calculation.
